(19) United States
(12) Patent Application Publication
(10) Pub. No.: US 2025/0050388 A1
(43) Pub. Date: Feb. 13, 2025

(54) SYSTEMS AND METHODS FOR DRAIN AND PIPE CLEANING AND INSPECTION

(71) Applicant: ENBASIS INC., Akron, OH (US)

(72) Inventors: Jason Richard TURSCHAK, Stow, OH (US); Christian James WIERZBICKI, Copley, OH (US); Evan Ray TIPTON, Richfield, OH (US); Alan Stephen GAFFNEY, Copley, OH (US); Fiona Marie GAFFNEY, Cleveland, OH (US); Nicholas Ryan LLEWELLYN, Doylestown, OH (US)

(21) Appl. No.: 18/799,048

(22) Filed: Aug. 9, 2024

Related U.S. Application Data
(60) Provisional application No. 63/518,926, filed on Aug. 11, 2023.

(51) Int. Cl. B08B 9/045; G01N 21/954; H04N 7/18; H04N 23/50; H04N 23/56

(52) U.S. Cl. CPC B08B 9/045; G01N 21/954; B08B 2209/04; H04N 7/183; H04N 23/555; H04N 23/56

(57) ABSTRACT

System and methods for cleaning and inspecting a pipe are disclosed. The system may include a flexible shaft having a distal end and a proximal end opposite the distal end, a sheath comprising a flexible tube body that extends over at least part of the flexible shaft and includes a distal end and a proximal end, wherein the flexible tube body includes a bore within which the flexible shaft extends, at least one electrical conductor contained within the flexible tube body of the sheath, the at least one electrical conductor extending at least partially along a length of the flexible tube body, and a camera operatively connected to the at least one electrical conductor.

### CROSS-REFERENCE TO RELATED APPLICATION

This priority to and the benefit of U.S. Provisional Patent Application No. 63/518,926 filed 11 Aug. 2023, the disclosure of which is hereby incorporated by reference in its entirety.

### FIELD OF THE DISCLOSURE

This disclosure relates generally to the plumbing and drain industry, and more specifically, but not exclusively, to systems and methods for drain and pipe cleaning and inspection.

### BACKGROUND OF THE DISCLOSURE

The plumbing and drain industry has long been focused on the development and improvement of systems for identifying and clearing blockages in pipes and drains. Blockages in plumbing systems can lead to significant issues, including water damage, health hazards, and costly repairs. Pipe and drain blockages in residential and commercial buildings largely affect the wellbeing of people for whom the plumbing and drain industry service as valued customers. As such, the ability to quickly and accurately identify and clear these blockages is of paramount importance.

Despite advancements in both identification and clearing technologies, there remains a significant gap in the market for a practical system that can both identify and clear blockages in one device. Existing systems and methods require the use of separate tools for identification and clearing, which can be time-consuming and inefficient. The need to switch between devices can also lead to inaccuracies in locating the blockage after it has been identified, as well as increased labor costs and downtime.

What is needed is a comprehensive combination of a pipe and drain inspection and cleaning capabilities incorporated within a single assembly that is cost effective, easy to manufacture, easy to repair, and has a small footprint. Such a combined system would streamline the identifying and clearing process, reduce the time and effort required, and improve the accuracy and of blockage management in plumbing systems. Such a system would be particularly beneficial in complex or extensive plumbing networks, where the ability to quickly and effectively address blockages is critical.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to an embodiment consistent with the present disclosure, a system for cleaning and inspecting a pipe is disclosed. The system includes a flexible shaft having a distal end and a proximal end opposite the distal end; a sheath including a flexible tube body that extends over at least part of the flexible shaft and includes a distal end and a proximal end, wherein the flexible tube body includes a bore within which the flexible shaft extends; at least one electrical conductor contained within the flexible tube body of the sheath, the at least one electrical conductor extending at least partially along a length of the flexible tube body; and a camera operatively connected to the at least one electrical conductor.

According to another embodiment, a system for cleaning and inspecting a pipe includes: a flexible shaft having a distal end and a proximal end opposite the distal end; a sheath including a flexible tube body that extends over at least part of the flexible shaft and includes a distal end and a proximal end, wherein the flexible tube body includes a central bore within which the flexible shaft extends; at least one electrical conductor contained within the flexible tube body of the sheath, the at least one electrical conductor extending at least partially along a length of the flexible tube body; a mount disposed at the distal end of the flexible tube body, wherein the at least one electrical connector extends to the mount; and a camera detachably supported by the mount and operatively connected to the at least one electrical conductor.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is a schematic diagram depicting an example of a system for cleaning and inspecting a pipe, according to one or more embodiments of the present disclosure.

FIG. 1B is a block diagram depicting exemplary example electronics of the system of FIG. 1A, according to one or more embodiments of the present disclosure.

FIG. 2 is an isometric view of a segment flexible shaft utilizable with the system of FIG. 1A, according to one or more embodiments of the present disclosure.

FIG. 3 is an isometric view of an example of a length of a sheath assembly utilizable with the system of FIG. 1A, according to one or more embodiments of the present disclosure, wherein the sheath assembly comprises a flexible tube body with electrical conductors extruded within a wall of the tube body.

FIG. 4 is perspective view of an example end assembly utilizable with the system of FIG. 1A.

FIG. 5A is an isometric view of another example sheath assembly with a flexible shaft, according to one or more embodiments of the present disclosure.

FIG. 5B is a cross-sectional view of an example of the sheath assembly of FIG. 5A without the flexible shaft.

FIG. 6A is an isometric view of another example sheath assembly with a flexible shaft, according to one or more embodiments of the present disclosure.

FIG. 6B is a cross-sectional view of an example the sheath assembly of FIG. 6A without the flexible shaft.

FIG. 7A is an isometric view of another example sheath assembly with a flexible shaft, according to one or more embodiments of the present disclosure.

FIG. 7B is a cross-sectional view of the sheath assembly of FIG. 7A without the flexible shaft.

FIG. 8A is an isometric view of another example sheath assembly with a flexible shaft, according to one or more embodiments of the present disclosure.

FIG. 8B is a cross-sectional view of sheath assembly of FIG. 8A without the flexible shaft.

FIG. 9A is an isometric view of another example sheath assembly with a flexible shaft, according to one or more embodiments of the present disclosure.

FIG. 9B is a cross-sectional view of the sheath assembly of FIG. 9A without a flexible shaft.

FIG. 10A is an isometric view of another example sheath assembly with a flexible shaft, according to one or more embodiments of the present disclosure.

FIG. 10B is a cross-sectional view of the sheath assembly of FIG. 10A without a flexible shaft.

FIG. 11A is an isometric view of another example sheath assembly with a flexible shaft, according to one or more embodiments of the present disclosure.

FIG. 11B is a cross-sectional view of the sheath assembly of FIG. 11A without a flexible shaft.

FIG. 12 is an example end assembly utilizable with the system of FIG. 1A, according to one or more embodiments.

FIG. 13 is a side view of the end assembly of FIG. 12.

FIG. 14 is isometric view of the end assembly of FIG. 12 when partially disassembled.

FIG. 15 is a side view of the end assembly of FIG. 12 when partially disassembled.

FIG. 16 is isometric exploded view of the end assembly of FIG. 12 when partially disassembled.

FIG. 17 depicts the front side of an embodiment of the system, according to one or more embodiments.

FIG. 18 a rear view of the system of FIG. 17.

FIG. 19 depicts an example electrical transition assembly utilized in the system of FIG. 17 to facilitate electrical connection between the electrical conductors and the electronics within the electronic enclosure.

FIG. 20 is isometric exploded view of the electrical transition assembly of FIG. 19 when partially disassembled.

FIG. 21 is cross-sectional view of the electrical transition assembly of FIG. 19.

FIG. 22 is side schematic view of the electrical transition assembly of FIG. 19.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure relate to the plumbing and drain industry, and more specifically, but not exclusively, to systems and methods for drain and pipe cleaning and inspection. The system includes a flexible shaft, a sheath assembly that includes a bore through which the flexible shaft may extend, and a camera supported at a distal end of the sheath assembly. The sheath assembly further includes at least one electrical conductor, such as a wire, wherein a distal end of the at least one electrical conductor is directly or indirectly in electrical communication with the camera. The system further includes electronics that are directly or indirectly in electrical communication with a proximal end of the at least one electrical conductor, such that the camera and the electronics are in communication with each other via the at least one electrical conductor. A bit may be attached to a distal end of the flexible shaft which extends distally from the bore, and the flexible shaft may be rotated independently or relative to the sheath assembly to clean an interior of a pipe while the camera captures operation of the bit for live streaming on a screen and/or for recording for later viewing. The electronics may include a battery and one of the electrical conductors may be utilized to supply power to the camera and a second of the electrical conductors is utilized to communicate camera data between the camera and the electronics. The system may also include an LED that is supported at the distal end of the sheath assembly, and the same electrical conductor utilized to supply power to the camera may also be used to supply power to the LED. The sheath assembly may be an exterior sheathing (or flexible tube body) through which the flexible shaft rotatably extends, and the sheath assembly may further include a mount at the distal end of the sheath assembly, and camera and/or the LED may be at least partially supported by the mount. Because the flexible shaft is operable to rotate independently of the exterior sheathing surrounding the flexible shaft, the camera is able to be secured/fixed to the exterior sheathing and held stable during operation, and the mount provides a means to secure/fix the camera to the exterior sheathing that is exterior the flexible shaft. Further, providing the camera allows a user to have a clear view of the interior of the pipe (e.g., during maintenance), thereby allowing the user to identify the blockage, orient the bit in an ideal position to clear the blockage, and ensure that the blockage was successfully removed in its entirety. Moreover, because the exterior sheathing does not rotate during operation relative to the flexible shaft, a user is able to safely grab this region (i.e., the user may hold/grab/grasp the exterior sheathing) when inserting/retrieving the bit and the flexible shaft into the pipe (even when the flexible shaft is rotating during operation). Additionally, the exterior sheathing is also able to be cleaned much easier than a traditional drain cleaning cable due to its smooth surface, thereby resulting in less mess and a more sanitary device. Even further, because the flexible shaft may be powered by a cordless drill and the electronics/camera may be powered by a local battery, the system need not be constrained by proximity to an electrical outlet. Furthermore, in embodiments where the system does not include an integrated motor, the absence of such an integrated motor allows the system to be more lightweight and compact, thereby further enhancing the ability of a single user to transport the system and operate it in confined spaces. While embodiments here may be used for inspection and removal of blockages, embodiments herein could also be used to perform preventative maintenance and ensure there is no buildup within the pipe, or a user could identify a problem that is unable to be resolved by the bit (or cleaning element) of the device (e.g., such as a collapsed or cracked pipe), but still finds use in the inspection alone by being able to identify the problem.

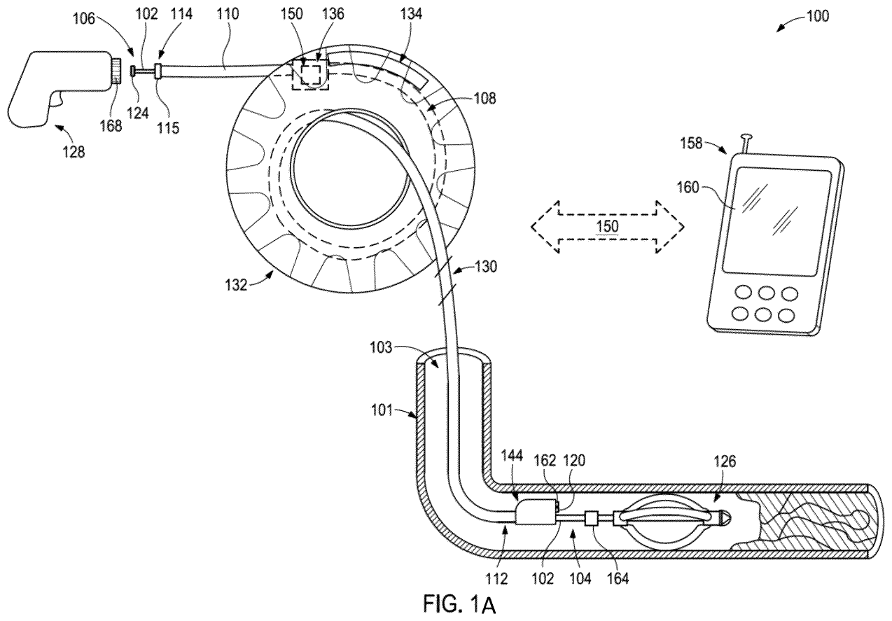

FIG. 1A depicts a cleaning and inspection system 100, according to one or more embodiments of the present disclosure. The cleaning and inspection system 100 (hereinafter, the system 100) may be utilized to clean and/or inspect a drain or a pipe. While FIG. 1A depicts the system 100 being utilized with respect to the pipe 101, the system 100 may be utilized to clean or inspect other structures without departing from the present disclosure, including but not limited to dryer vents, air ducts, chimney ducts, etc. In the illustrated embodiment, the system 100 includes a flexible shaft 102, a sheath assembly 108 (hereinafter, the “sheath 108”), and at least one electrical conductor 118. The system 100 may also include a camera 120 that is operable to capture images, for example, from within a bore 103 of the pipe 101 or drain or other structure within which the system 100 is inserted into as hereinafter described.

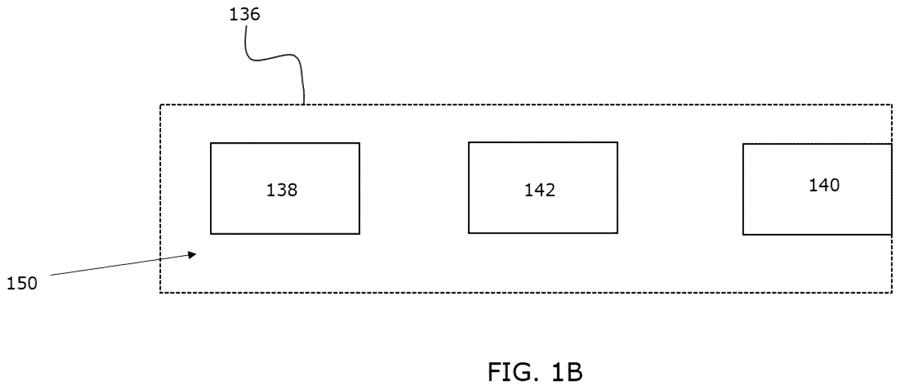

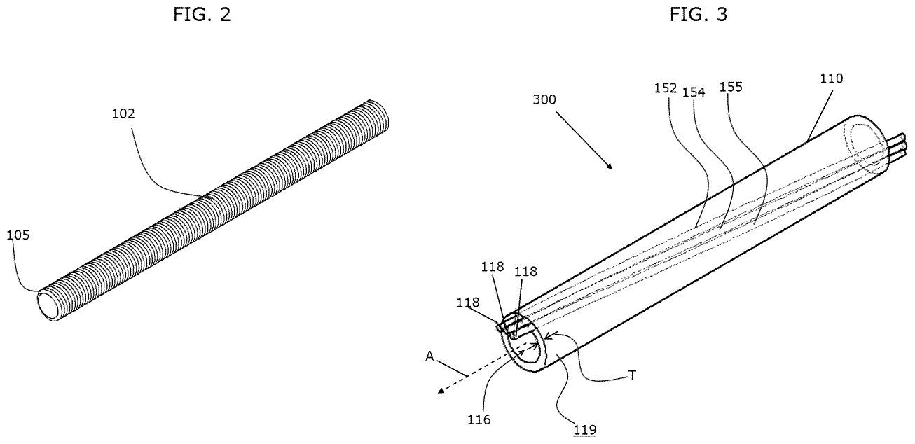

The flexible shaft 102 includes a distal end 104 and a proximal end 106 opposite the distal end 104. A coupling 124 is attached to the proximal end 106 of the flexible shaft 102, and a bit 126 may be operatively attachable to the distal end 104 of the flexible shaft 102. FIG. 2 depicts a segment of the flexible shaft 102, according to one or more embodiments. In particular, FIG. 2 depicts a segment of the flexible shaft 102 that may rotatably be arranged within the sheath 108, such as the sheath 108 exemplified in FIG. 3. The flexible shaft 102 may include multiple layers of one or more wires wound at opposing pitch angles that enable the flexible shaft 102 to operate bi-directionally (clockwise and counterclockwise). However, in other embodiments, the flexible shaft 102 may also be unidirectional. The flexible shaft 102 may rotate within and independently of/relative to the sheath 108. During use, the flexible shaft 102 has the ability to transmit rotary motion while being subjected to several bends, as detailed herein. Thus, as shown, the flexible shaft 102 may be constructed from high tensile strength wire 105 that is wound at opposing pitch angles. The wire 105 from the flexible shaft 102 is constructed may be a metal wire, such as but not limited to stainless steel, carbon steel, titanium, nickel-chromium alloys, phosphor bronze, or nickel-copper alloys; or fibrous or composite materials such as Kevlar. As described below, the flexible shaft 102 is operable to rotate independent of the sheath 108 and, in embodiments, one or more collars may be arranged on the flexible shaft 102 that could be arranged to maintain a fixed distance between a portion of the shaft 102 and the sheath 108.

Referring again to FIG. 1A, the bit 126 may be various types of tools utilized to clean, repair, and/or inspect pipe or plumbing components. The bit 126 may be removably fastened/connected to the distal end 104 of the flexible shaft 102 to effectively clean rust, dirt, and/or debris from within the bore 103 of the pipe 101 or drain line. In embodiments, the bit 126 is a chain knocker having one or more sections of chain which are flung radially outward as the bit 126 is rotated. One or more carbide inserts can be brazed or otherwise attached to the chain section(s) to promote cleaning and reduce wear otherwise occurring on the chain surfaces. The bit 126 may also include, without limitation, cutting/boring heads, sandpaper holders, brushes, or retrieval tools. Other examples of tools that may be utilized as the bit 126 include (but are not limited to) drain auger heads, descaling tools, or pipe deburring tools. In embodiments, the bit 126 is removable from the distal end 104 of the flexible shaft 102. When in use, the bit 126 may be extended/inserted into the pipe 101 (e.g., through a drain and into the pipe 101) and thereafter the system 100 may be activated to thereby interact with the interior of the pipe 101 (e.g., to clean the pipe 101, to remove debris in the pipe 101, etc.). In embodiments, a chuck 164 is disposed/arranged at the distal end 104 of the flexible shaft 102 to facilitate removal and installation of various types of bits 126 on the flexible shaft 102. In other embodiments, a “T slide” connector may be utilized in addition to or in lieu of the chuck 164 for facilitating attachment of the bit 126 on the flexible shaft 102. For example, the “T slide” connector may have a male end crimped or otherwise attached to the distal end 104 of the flexible shaft 102 and a female end attached to a proximal end of the bit 126, wherein the female end of the “T slide” connector may be selectively attached to the male end to thereby attach the bit 126 on the flexible shaft 102. In embodiments, the “T slide” connector may be utilized at the proximal end 106 of the flexible shaft 102 to facilitate connection of the coupling 124 (e.g., a drill adapter to be received in the chuck of a handheld drill) to the flexible shaft 102.

The system 100 may also include a rotation device 128 configured to impart rotation to the flexible shaft 102. As shown the rotation device 128 may be operatively coupled to the proximal end 106 of the flexible shaft 102, and the rotation device 128 is operable to rotate the flexible shaft 102 relative to the sheath 108. In embodiments, the rotation device 128 may be a handheld power drill (battery powered or corded); whereas, in other embodiments, the rotation device 128 may be an unpowered drill that is actuated via a hand crank. In further embodiments, the rotation device 128 may include an integrated motor (e.g., the system 100 may include an integrated motor for causing rotation of the flexible shaft 102 relative to the sheath 108). However, other types of rotation devices 128 may be utilized to impart rotation to the flexible shaft 102 without departing from the present disclosure. In the illustrated embodiment, the flexible shaft 102 includes a coupling 124 at the proximal end 106, and the rotation device 128 may include a second chuck 168 that is operable to releasably/selectively grasp and be fastened to the coupling 124, as may be desired.

The sheath 108 includes a flexible tube body 110 that extends over at least part of the flexible shaft 102. As shown in at least FIG. 1A, the flexible tube body 110 includes a distal end 112 and a proximal end 114 that is opposite the distal end 112. As best shown in FIG. 3, the flexible tube body 110 includes a bore 116 within which the flexible shaft 102 may extend when inserted there-through. The bore 116 may be formed within the flexible tube body 110 such that at least a portion of it extends along an axis A. In embodiments, the bore 116 is centered within the flexible tube 102 when evaluated in cross-section, such that the bore 116 is a centrally located bore when evaluated in cross-section (i.e., the bore 116 may be centered within the flexible tube body 110 when evaluated in cross-section); however, the bore 116 need not be centrally located and may instead extend through the flexible shaft 102 at a location that is off-set (or off-center) from a center or central location. In the example depicted in FIG. 3, the bore 116 is centered within the flexible tube body 110. In embodiments, one or more collars may be arranged on the flexible shaft 102 that constrain axial movement of the flexible tube body 110 relative to the flexible shaft 102. For example, a collar may be arranged on the flexible shaft 102, proximal from the bit 126 and distal from the distal end 112 of the flexible tube body 110, to thereby maintain the bit 126 at a fixed distance from the distal end 112 of the flexible tube body 110. In embodiments, an additional shaft collar(s) may be fastened to the flexible shaft 102 just behind (or proximal from) the proximal end 114 of the flexible tube body 110 to thereby inhibit the flexible shaft 102 from moving forward/distal or backward/proximal within the flexible tube body 110, such that axial movement of the flexible shaft 102 relative to the flexible tube body 110 is constrained.

In embodiments, an end fitting 115 (e.g., a ferrule) is arranged at the distal end 112 and/or the proximal end 114 of the flexible tube body 110 so as to help inhibit fraying of the flexible tube body 110. In embodiments, the end fitting 115 may be crimped or threaded onto the distal end 112 and/or the proximal end 114 of the flexible tube body 110.

When the system 100 is assembled, with the flexible shaft 102 arranged within the bore 116 of the flexible tube body 110 such that the sheath 108 covers at least a portion of the overall length of the flexible shaft 102, the distal end 104 of the flexible shaft 102 may extend out of and distally beyond the distal end 112 of the flexible tube body 110 and the proximal end 106 of the flexible shaft 102 may extend out of and proximally beyond the proximal end 114 of the flexible tube body 110, as exemplified in FIG. 1A. During use, the flexible shaft 102 is operable to rotate within the bore 116 of the flexible tube body 110, such that the flexible shaft 102 may rotate independently of and relative to the sheath 108. The system 100 may also include a sheath-end fitting configured to attach to the sheath 108 and prevent or limit contact between the sheath 108 and the flexible shaft 102 as the flexible shaft 102 rotates relative to the sheath 108. The sheath-end fitting may not join/connect the sheath 108 and the flexible shaft 102 together, but may prevent, inhibit, or limit damage at the point where they would otherwise make contact and abrade each other, and the sheath-end fitting may also limit contact between the sheath 108 and the bit 126 at the distal end 104 of the flexible shaft 102 and limit contact between the sheath 108 and the coupling 124 at the proximal end 106 of the flexible shaft 102. In embodiments, an end fitting 115 (e.g., a ferrule) is arranged at the distal end 112 and/or the proximal end 114 of the flexible tube body 110 so as to help inhibit fraying/damage of the flexible tube body 110 that may result from such abrading. In embodiments, the end fitting 115 may be crimped or threaded onto the distal end 112 and/or the proximal end 114 of the flexible tube body 110.

The system 100 also includes at least one electrical conductor 118 contained within the flexible tube body 110 of the sheath 108. By containing the at least one electrical conductor 118 within a thickness of the flexible tube body 110, the at least one electrical conductor 118 will be protected from damage during use. FIG. 3 depicts an example of a length of flexible tube body 110, such as the central segment 130 of the flexible tube body 110 shown in FIG. 1A, with at least one electrical conductor 118 contained within the wall thickness T of the flexible tube body 110 utilizable with the system 100 of FIG. 1A, according to one or more embodiments of the present disclosure. In the illustrated embodiment, there are three (3) electrical conductors 118 contained within and extending through the wall thickness T of the flexible tube body 110; however, more or less than three (3) electrical conductors 118 may be included. Also in the illustrated embodiment, each of the electrical conductors 118 extends parallel with each other, but one or more of the electrical conductors need not run parallel with the others. In an embodiment, the tube body 110 formed via extrusion with the at least one electrical conductor 118 being at least partially embedded within the wall thickness T thereof so that the at least one electrical conductors 118 is at least partially covered by the flexible tube body 110 of the sheath 108.

The at least one electrical conduct 118 may generally extend in parallel with the flexible tube body 110 of the sheath 108 and the flexible tube 102, as depicted in FIG. 3; however, one or more of the electrical conductors 118 need not run parallel with the tube body 110 of the sheath 108 and the flexible tube 102. Also, as hereinafter described, the at least one electrical conductor 118 may be contained and extend within the flexible tube body 110 such that it is not exposed to the ambient environment. Thus, the at least one electrical conductor 118 is covered/confined by the flexible tube body 110 or the at least one electrical conductor 118 is encapsulated/encased/embedded within the flexible tube body 110. In this manner, when the distal end 112 of the sheath 108 is inserted into the tube 101, the at least one electrical conductor 118 need not be exposed to the ambient environment within the bore 103 of the tube 101 which could otherwise damage the electrical conductor 118. In embodiments, the at least one electrical conductor 118 may extend the entire length of the flexible tube body 110 between the distal and proximal ends 112, 114; however, in other embodiments, at least one of the at least one electrical conductor 118 extends less than the entire length of the flexible tube body 110 (i.e., at least one of the at least one electrical conductor 118 extends at least partially along a length of the flexible tube body 110). For example, the at least one electrical conductor 118 may extend through a portion of the flexible tube body 110 (e.g., through the central segment 130 of the flexible tube body 110 as exemplified in FIG. 3) but exit the flexible tube body 110 before reaching the distal end 112 and/or the proximal end 114, so as to facilitate attachment of the electrical conductor 118 to other components of the system 100, as detailed below. The central segment 130 may be any length or distance defining a region of the flexible tube body 110 such that the region starts and ends before the distal end 112 and/or proximal end 114.

Any length/segment of the at least one electrical conductor 118 may be fully contained within the wall thickness T of the flexible tube body 110, such that it is encased or encapsulated within the material that forms the flexible tube body 110 so as to shield or protect the electrical conductors 118 from the rotating flexible shaft 102 within the bore 116 or the ambient environment within which the flexible tube body 110 will be exposed during operation. For example, FIG. 3 depicts a cylindrical segment 300 of the flexible tube body 110 that may be representative of the central segment 130 of the sheath 108. FIG. 3 also exemplifies how the at least one electrical conductor 118 (shown in dashed lines) may continuously run/extend, generally along the axis A (e.g., helically around the bore 116 or parallel with the axis A) and through the wall thickness T of the central segment 130 of the flexible tube body 110, without extending/protruding radially into the bore 116 or extending/protruding radially outward from an outer surface 119 of the flexible tube body 110. Thus, the material of the flexible tube body 110 separates the at least one conductor 118 from the bore 116 and the ambient environment contacting the outer surface 119. In FIG. 3, the material of the flexible tube body 110 is an annular shaped material and the at least one electrical conductor 118 extends through the annular shaped material of the flexible tube body 110 helically around the bore 116 and the axis A; however, the at least one electrical conductor 118 may also or instead extend through the annular shaped material of the flexible tube body 110 in a direction that is parallel with the axis A.

The at least one electrical conductor 118 also need not be fixed relative to the flexible tube body 110 of the sheath 108, such that the electrical conductor 118 may move relative to the sheath 108, which will help inhibit tearing/stretching/wear of the electrical conduct 118 as the sheath 108 and the flexible shaft 102 are wrapped and bent during use and storage. In some embodiments, the at least one electrical conductor 118 may be ran in parallel. In other embodiments, the at least one electrical conductor 118 may be in a wound or wrapped orientation. Such parallel or wound or wrapped orientations of the at least one electrical conductor 118, while being unfixed relative to the segment of the flexible tube body 110 of the sheath 108 within which it/they extend, may permit the at least one electrical conductor 118 to have the ability to draw slack, stretch, compress, or any otherwise fluid movement. For example, the length of the at least one electrical conductor 118 contained within a particular segment of the flexible tube body 110 may be longer than the length of the segment of the flexible tube body 110 so as to provide slack to the at least one electrical conductor 118 when the sheath 108 is bent, as such bending may cause the at least one electrical conductor 118 to be subject to a relatively larger bending radius and the slack will accommodate such relatively larger bending radius.

Examples of the at least one electrical conductor 118 include wires, cables, or other conductive ribbons or conductive braided mesh capable of being contained within the flexible tube body 110 of the sheath 108. The at least one electrical conductor 118 may include a single-core wire insulated with a plastic or rubber coating for example. In other embodiments, the at least one electrical conductor 118 may be a multi-core cable, such as a ribbon cable which are flat and flexible and suitable for narrow spaces. Multi-core cables may come in other orientations, such as parallel, spiral, helix, braided or other twisted orientations. The at least one electrical conductor 118 may be twisted clockwise or counter-counterclockwise. The at least one electrical conductor 118 may also include, but not be limited to, coaxial cables, micro-coaxial cables, twisted pair cables, shielded cables, flexible flat cables (FFC), fiber optic cables, silicone insulated cables, or magnet wires. In some embodiments, the at least one electrical conductor may include a jacketed cable, which may further include various shielded or insulated wires. The at least one electrical conductor 118 may also include electrical contacts provided at either end of the at least one electrical conductor 118 to engage corresponding electrical contacts of another component, such as the camera 120, to effectuate electrical communication. For example, the at least one electrical conductor 118 may include electrical contacts at a distal end(s) of the at least one electrical conductor 118, and such electrical contacts at the distal end(s) of the at least one electrical conductor 118 may be arranged to contact corresponding contacts arranged on the camera 120. Similarly, a proximal end of the at least one electrical conductor 118 electrical contacts configured to engage other electrical components of the system 100, for example, electrical components contained within a housing of the system 100 as detailed below.

Referring again to FIG. 1A, the system 100 may also include a camera 120 for capturing images from within the pipe 101. The images may be still images or video footage. In embodiments, the images may come in a variety of resolutions, such as high-resolution. The imaging may be provided by either digital or analog image sensors within the camera 120. In embodiments, the camera 120 may be capable of capturing images in a plurality of imaging formats, including but not limited to color, black and white, or infrared thermography (IRT) also known as thermal imaging. In embodiments, the camera 120 is a waterproof, bullet-style camera with LEDs that utilizes a composite video signal, such as NTSC video format with 480p resolution.

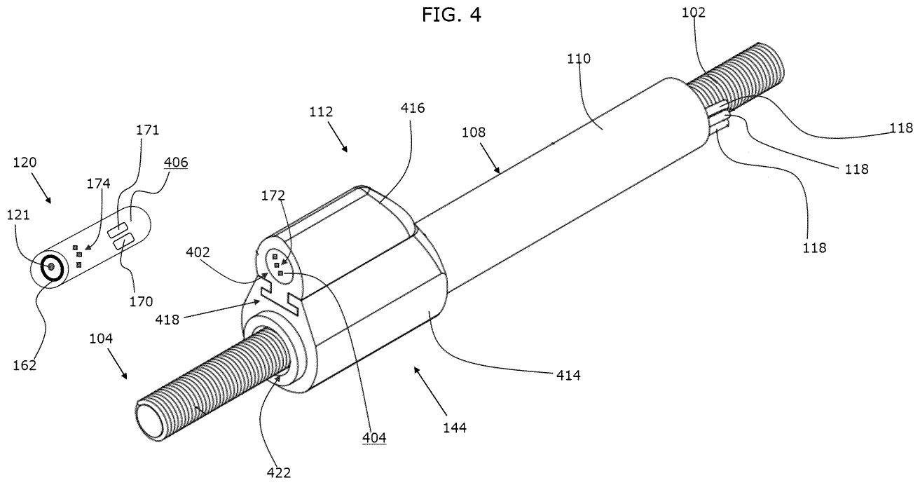

The camera 120 is operatively connected to the at least one electrical conductor 118, as hereinafter described. In the embodiment exemplified in FIG. 4, the camera 120 (which is depicted when disassembled/removed from the proximal end 112 of the sheath 108) includes at least one electrical contact 174 that corresponds with and will directly or indirectly engage/couple with the at least one electrical conductor 118 when assembled. Here, corresponding electrical contacts 172 that are each in electrical communication with an individual one of the at least one electrical conductors 118 will contact/engage the electrical contact(s) 174 of the camera 120 when the camera 120 is assembled on the distal end 112 of the sheath 108. More specifically, in this example, each of the three (3) electrical conductors 118 is associated with one of the three contacts 172, the each of three (3) contacts 172 will contact/engage an associated one of the three (3) contacts 174 of the camera 120 when the camera 120 is installed in the proximal end 112 to thereby establish electrical communication between the camera 120 and the at least one electrical conductor 118 to allow data and power transmission as detailed below; however, more or less than three (3) of the contacts 172, 174 may be utilized.

In embodiments, the camera 120 may be detachable from the at least one electrical conductor 118. FIG. 4 depicts an example where the camera 120 is detachable from the distal end 112 of the sheath 108 as well as the electrical conductors 118. Here, when the camera 120 is installed in the distal end 112 of the sheath 108, the contacts 174 of the camera 120 will engage/contact the contacts 172, to thereby establish electrical communication between the camera 120 and the at least one electrical conductor 118 to allow data and power transmission as detailed below. In this embodiment, each of the three (3) contacts 172 may be physically connected to the distal end of an individual one of the three (3) electrical conductors 118; however, in other embodiments, one or more intervening conductors may be arranged between any one of the contacts 172 and its associated electrical conductor 118 to enable data/power transmission between the electrical conductor 118 and its associated contact 172.

In other embodiments where the camera 120 is detachable, quick-connect/disconnect connectors may be used for coupling the camera 120 to the at least one electrical conductor 118. The connectors may include threaded means of connection or push-to-connect connections, with or without retaining clip. The connectors may be waterproof or include a surrounding housing or mount that may be sealed and made waterproof. In embodiments, a screw-in terminal may be used if the housing were made waterproof. In other embodiments, the camera 120 may be fixed or not treated as a field replaceable component; and in such embodiments, a soldered or sealed connection may be used. Such connections may further include a sealed crimped connection or a sealed insulation-displacement connection. For example, where the camera 120 is fixed to the sheath 108 (e.g., at the distal end 112 thereof), each of the at least one electrical conductors 118 may be physically connected to the camera 120 (e.g., at the connectors 174), or each of the each of the at least one electrical conductors 118 may be physically connected to the camera 120 via at least one intervening conductor.

Referring again to FIG. 1A, the system 100 may also include a case 132. The case 132 is a housing within which at least some of the flexible shaft 102 and the flexible tube body 110 of the sheath 108 may be stored. The camera 120 supported on the distal end 112 of the sheath 108 and the bit 126 arranged on the distal end 104 of the flexible shaft 102 may also be stored in the case 132, so as to protect the camera 120 when not in use. In preparation of using the system 100, distal segments of the flexible shaft 102 and the flexible tube body 110 may be extended or withdrawn from the case 132, and then, after use, they may retracted or reinserted back into the case 132 for storage. In embodiments, the case 132 includes a handle 134. In embodiments, the case 132 is a drum or disc shaped housing. The case 132 may store the flexible shaft 102 and the flexible tube body 110 in any orientation, such as but not limited to coiling, spooling, stacking, accordion/zig-zag folding, braiding, telescoping, or nesting. In embodiments, the case 132 may include a retractable mechanism which would extend the flexible shaft 102 and flexible tube body 110 out of the case 132 when needed or retract back into a compact form within the case for storage. The case 132 may be constructed from any material, such as materials that promote durability, or resistance to wear. The material may be polymeric or non-polymeric. In embodiments, the case 132 is made from a metal material including but not limited to stainless steel or aluminum. In other examples, the case 132 is made from a high-density polyethylene, polyvinyl chloride (PVC), nylon, rubber, polyurethane, or other composite materials or plastic blends. In embodiments, the case 132 is manufactured via rotational molding process using a polyethylene material, including but not limited to LDPE, HDPE, XLPE, LLDPE, PVC, nylon, or polypropylene. However, other types of materials and/or manufacturing processes/techniques may be utilized to construct the case 132 without departing from the present disclosure.

The system 100 may also include an electrical enclosure 136. FIG. 1A depicts an example arrangement of the electrical enclosure 136 relative to the case 132, according to one or more embodiment. The electrical enclosure 136 may contain electronics 150, and FIG. 1B depicts an example arrangement of the electronics 150 contained within the electrical enclosure 136, according to one or more embodiments. In embodiments, the electronics 150 may include (but not be limited to) a battery 138, a wireless transceiver 140 (or other type of computing device operable to serve as a wireless access point), and a processor 142, etc. In embodiment, the electronics 150 may also include components that are compatible interface for converting composite signals (such as AHD or CVBS input) to a USB digital output signal. Any one or more of these electronics 150 may be embodied or incorporated within a printed circuit board (PCB), or they may be embodied in more than one separate modules that are connectable together to function. As explained below with reference to FIG. 4, the system 100 may also include a sonde 170 and/or an accelerometer 171 that are in communication with the electronics 150. In embodiments where the sonde 170 and/or the accelerometer 171 are included, the sonde 170 and/or the accelerometer 171 may be in electrical communication with the electronics 150 via the at least one conductor 118, but may be located exterior the electrical enclosure 136, for example, in the distal end 112 of the sheath 108 and/or integrated within the camera 120 as exemplified in FIG. 4.

Where included, the accelerometer 171 may share the same board as the camera 120 and receive power from the same electrical conductor 118 utilized to supply power to the camera 120; however, a separate electrical conductor 118 may be used to transmit the accelerometer data back to the proximal end of the system 100 and associated electronics 150 within the electrical enclosure 136.

Where included, the sonde 170 and/or the accelerometer 171 may be supplied with power from the battery 138 via the electrical conductors 118, and the electronics 150 may include components for regulating voltage supplied to the sonde 170 and/or the accelerometer 171. Also, the electronics 150 may be configured to ingest and interpret signal received from the sonde 170 and/or the accelerometer 171, or such interpretation may be performed elsewhere about the system 100, for example, on a user's remote device (e.g., smart phone) as detailed below. Where the sonde 170 is utilized, the system 100 may also include a locator device (not shown) to determine location of the distal end 112 of the sheath 108. Here, the sonde 170 acts as a radiofrequency (RF) transmitter and the locator device is a handheld receiver that picks up the signal emitted from the sonde 170, for example, as used in the utility industry for locating pinpointing the paths of cables, pipes and other conduits that carry utilities underground.

The electronics 150 contained within the electrical enclosure 136 are (directly or indirectly) operatively connected to the camera 120 via the at least one electrical conductor 118. Thus, the at least one electrical conductor 118 are configured to be in electrical communication with the electronics 150 contained within the electrical enclosure 136. For example, the at least one electrical conductor 118 may physically extend into the electrical enclosure 136 and be operatively connected to the electronics 150 contained in the enclosure 136. In embodiments, the electrical enclosure 136 is removably attached to the case 132. In embodiments, the electrical enclosure 136 may be disposed on an interior of the case 132, whereas in other embodiments, the electrical enclosure 136 may be disposed on an exterior of the case 132. For example, a pocket may be molded into the case 132 to store the electronics 150 and a separate lid or plate may be pivotably coupled to the case 132 to cover the pocket, according to an embodiment. Conversely, a separate housing may be molded into the exterior of the case 132 to store the electronics 150. In embodiments, a mounting bracket is utilized to (removably or non-removably) attach the electrical enclosure 136 to the case 132.

In embodiments, the at least one electrical conductor 118 may include an electrical connector (e.g., arranged at a proximal end of the electrical conductor 118) that may be connected to a mating connector that is arranged on or inside the electrical enclosure 136 and that is in electrical communication with the electronics 150 housed therein. For example, a waterproof circular connector may be used to connect the at least one electrical conductor 118 from the sheath 108 to the electrical enclosure 136, according to at least one embodiment. In further embodiments, a transitional connector may be clamped onto the sheath 108 at that connects the proximal end of at least one electrical conductor 118 to a cable or connector running into the electrical enclosure 136.

Referring now to FIG. 3, in the illustrated embodiment, the at least one electrical conductor 118 may include a first conductor 152 that interconnects the camera 120 and the battery 138 and a second conductor 154 for providing a means of transmitting data 156 (see FIG. 1A) associated with the camera 120 between the camera 120 and the electronics 150. The second conductor 154 may be operatively coupled to the electronics 150, and the electronics 150 may be configured to wirelessly transmit the data 156 to a remote device 158, such as a smart phone or tablet.

In embodiments, the remote device 158 may include a screen 160. The data 156 transmitted from the electronics 150 to the remote device 158 may be displayed on the screen 160 for viewing by the operator/user. The remote device 158 may be any computing devices operated by respective users. Example remote devices 158 may include, but are not limited to, a smartphone; smart glasses; VR/AR headset; a camera; a personal computer; a laptop computer; a personal digital assistant; a data-enabled cellular telephone; kiosk; embedded device; console; or a notebook or tablet computer. Such a device may also include software, firmware, hardware, or a combination thereof. Software may include one or more applications, a browser, and an operating system. Operating systems may include, but are not limited to, Microsoft Windows™; Android™; WebOS™; or iOS™ or a custom operating system. Hardware may include, but is not limited to, a processor, memory, display or other input/output device. A communication interface and transceiver may be included to perform data communication (wired or wireless) with the electronics 150 (e.g., the transceiver 140). The screen 160 may be a liquid crystal display (LCD), LED screen, OLED screen, AMOLED screen, thin film transistor (TFT) LCD Screen, or otherwise have touchscreen capabilities. However, other types of screen 160 may be used without departing from the present disclosure. The screen 160 may also or alternatively be located on the case 132 and/or on the electronics enclosure 136, according to other embodiments consistent with the present disclosure.

Referring again to FIG. 1A, system 100 may further include a light 162 supported proximate to the distal end 112 of the flexible tube body 110 for providing illumination. In embodiment, the light 162 is an LED and, therefore, the light 162 is sometimes hereinafter referred to as the LED 162. In the embodiment depicted in FIG. 3, the at least one electrical conductor 118 also includes a third conductor 155 that interconnects the battery 138 and the LED 162, in addition to the first conductor 152 and the second conductor 154 for transmitting power and camera data between the camera 120 and the electronics 150, according to an embodiment consistent with the present disclosure. In other embodiments, power may be supplied to the LED 162 and the camera 120 via the same electrical conductor 118, and in such embodiments, the electronics 150 may include a circuit board in the enclosure 136 that is shared by the camera 120 and the LED 162. Here, for example, the electrical conductors 118 may include just the first conductor 152 and the second conductor 154, and the first conductor 152 may be used to supply power to both the LED 162 and the camera 120, and the second conductor 154 may be used for transmission of camera data between the camera 120 and the electronics 150; however, the conductors 118 may also include the third conductor 155 which is configured as a ground wire/conductor. Thus, the LED 162 and camera 120 may be powered by the same at least one electrical conductor 118 or separate conductors, and additional electrical conductors may be utilized for transmitting data and providing a ground.

The LED 162 is configured to illuminate the inside of the pipe 101 for inspection. Illumination may be beneficial for the camera 120 to be able to produce clean and visible images of the inside of the pipe 101 for inspection. The LED 162 may be a surface-mounted device (SMD) LED, for example. Other types of usable LEDs include chip-on-board (COB) LEDs, flexible strip LEDs, infrared LEDs, ultraviolet LEDs, waterproof LEDs, side-emitting LEDs, or micro LEDs. However, other types of a LED 162 may be utilized without departing from the present disclosure. In an embodiment, the LED 162 may be integrated within the camera 120 in the form of an LED ring around a lens of the camera 120. In other embodiments, the LED 162 may be one or more LEDs separately integrated into the camera 120 or mount 144. In the embodiment depicted in FIG. 4, the LED 162 is arranged as a ring shaped LED that surrounds an aperture 121 of the camera 120. Here, the LED 162 is depicted as being integrally included within the camera 120; however, in other embodiments, the LED 162 may be a separate component from the camera 120.

The system 100 may also include a mount 144 for supporting the camera 120 and/or the LED 162. FIG. 4 depicts an example embodiment of the mount 144, according to an embodiment. As shown, the mount 144 may be disposed or otherwise supported at the distal end 112 of the flexible tube body 110. The camera 120 may be arranged in/on or otherwise supported by the mount 144. Here, the mount 144 defines a bore 402 and the camera 120 is insertable within the bore 402 of the mount 144. As mentioned, the camera 120 may be a module that is configured to be inserted into the bore 402. In this embodiment, the contacts 172 (which are each associated with one of the electrical conductors 118) are arranged on an inner bore surface 404 of the bore 402 and exposed on the inner bore surface 404 such that the contacts 174 arranged on an outer surface 406 of the camera 120 can mate with their corresponding contacts 172 when the camera 120 is installed in the distal end 112 by inserting the camera 120 within the bore 402 of the mount 14. Thus, the bore 402 may further include the electrical contacts 172 exposed on its inner bore surface 404 where such electrical contacts 172 are exposed and positioned to contact other electrical contacts 174 of the camera 120 such that the bore 402 of the mount 144 may further be in electrical communication with the at least one electrical conductor 118.

In the illustrated embodiment, the sonde 170 and the accelerometer 171 are integrated with or arranged on the camera 120; however, in other embodiments, the sonde 170 and/or the accelerometer 171 may be provided elsewhere about the system 100, for example, on or in the mount 144 or at the distal 112 of the sheath 108. In other embodiments, the sonde 170 includes an integral battery, such that it does not need to be physically connected to the power supply 138 via the electrical conductor 118 to receive power, and in such embodiments the battery powered sonde may be located elsewhere about the system 100, for example, at the distal end 104 of the flexible shaft 102 and/or integrated within the bit 126. In such embodiments where the sonde 170 includes its own power source, it need not be in electrical communication with any of the electronics. Rather, such battery powered sonde would simply be readable by the locator device, detailed above, which is a separate handheld device utilized to detect and locate the sonde.

In other embodiments, however, the mount 144 need not be included and the camera 120 may be attached directly on the flexible tube body 110, for example, on the distal end 112 of the sheath 108. For example, where the flexible tube body 110 includes a dual-lumen configuration, as detailed below, in which the flexible tube body 110 includes a lumen for the electrical conductors 118 (in addition to the bore 116 through which the flexible shaft 102 extends), the camera 120 may be inserted within the distal end of the lumen within which the electrical conductors 118 extend, thereby facilitating attachment between the camera 120 and the electrical conductors 118.

In some embodiments, the mount 144 may include one or more parts. For example, in the embodiment in FIG. 4, the mount 144 may include a first part 414 and a second part 416 that is removable from the first part 414, wherein the first part 414 is connected to the flexible tube body 110 of the sheath 108 and the second part 416 supports the camera 120. Here, the bore 402 is defined within the second part 416 of the mount 144, such that the camera 120 is removable from the second part 416 of the mount 144 by removing the camera 120 from the bore 402. In some embodiments, though, the camera 120 may be permanently fixed or installed within the bore 402, such that the camera 120 is removable by removing the second part 416 of the mount from the first part 414 of the mount 144, wherein the first part of the mount may be fixed/secured on the flexible tube body 110 of the sheath 108. Here, the first part 414 and the second part 416 of the mount 144 are connectable to each other via a dove tail joint 418; however, other means may be utilized to connect the first and second parts 414, 416, including but not limited other types of joints, threads, magnets, adhesive, etc.

In the illustrated embodiment, the mount 144 also includes a bore 422 through which at least the flexible shaft 102 may extend. The bore 422 may also surround or otherwise couple to the sheath 108. The bore 422 may be defined as a hollow area molded into the structure of the mount 144, regardless of how many parts the mount 144 may be constructed of.

Where the mount 144 is included, the at least one electrical conductor 118 may extend to the mount 144. For example, the at least one electrical conductor 118 may terminate at electrical contacts 172 arranged on the mount 144, where such electrical contacts 172 are exposed and positioned to contact the corresponding electrical contacts 174 of the camera 120, to thereby establish electrical communication between the camera 120 and the at least one electrical conductor 118 when the camera 120 is installed in the mount 144. In embodiments, the camera 120 may be permanently fixed/attached/secured to the mount 144. In other embodiments, the camera 120 may be removable from the mount 144. The mount 144 may also house connection between the at least one electrical conductor 118 of the sheath 108 and the electrical contacts 172 of the mount 144. For example, the mount 144 may house electrical connections/conductors/wires (not shown) that have opposite ends, with a first end of each of such opposite ends terminating at one end at the electrical contacts 172 and a second end of each of such opposite ends terminating terminate at a proximal contact that engages (or otherwise is coupled/connected to) the distal end of the electrical conductor 118. Accordingly, electrical communication through the mount 144 may be achieved for each of the at least one electrical conductors 118.

The mount 144 may be fixed to the sheath 108 as well as to the camera 120 in many ways, including (but not limited to) clamping, crimping, using adhesives, or using push-on retention nuts. The mount 144 may be secured to and/or around the sheath 108 via screw bosses, threaded inserts, or recessed nuts in conjunction with threaded fasteners. In an embodiment, the mount 144 may be made of plastic and secured to and/or around the sheath 108 by snap-fit connectors.

In other embodiments, the mount 144 may be made of metals such as aluminum, stainless steel, or copper; plastics such as polycarbonate, acrylonitrile butadiene styrene, or nylon; composites such as carbon fiber reinforced polymer or glass fiber reinforced polymer; ceramics or elastomers such as silicone rubber. However, other materials may be used to construct the mount 144 without departing from the present disclosure. In embodiments where the mount 144 is constructed of more than one parts, each part may be constructed of the same or different materials or any combination therein. The mount 144 may further include insulation to differentiate between any metallic electrical contacts 174 arranged on the mount 144 and metallic materials the mount 144 may be constructed from.

Where the mount 144 is not included, the at least one electrical conductor 118 may terminate electrical contacts disposed at the distal end 112 of the flexible tube body 110, where such electrical contacts are exposed and positioned to contact the corresponding electrical contacts 174 of the camera 120, to thereby establish electrical communication between the camera 120 and the at least one electrical conductor 118.

The sheath 108 is configured to protect against the wear of internal components of the system 100, namely the at least one electrical conductor 118. The sheath 108 also protects the flexible shaft 102 arranged within the sheath 108, helping to prevent the flexible shaft 102 from kinking, and protecting the user from the rotating flexible shaft 102. The sheath 108 may be made of flexible and wear-resistant materials. As will be appreciated by those skilled in the art, there are numerous ways to accomplish this. For example, the sheath 108 may be an extruded material with the electrical conductors 118 embedded therein, and/or the sheath 108 be constructed as a composite, with a fibrous membrane located in between two regions of polymeric materials. The polymeric materials may include but are not limited to polyolefins (polyethylene and polypropylene), cross-linked polyolefins, and nylon. The polymeric materials may be chosen for flexibility, durability (wear/puncture resistance), chemical compatibility and lubricity (coefficient of friction). The sheath 108 may also be in the form of a single layer of materials or comprise two or more layers of material. The sheath 108 may be any diameter or length, though in some embodiments it may be slightly shorter than the length of the flexible shaft 102 or the at least one electrical conductor 118, such that a section of the flexible shaft 102 or the at least one electrical conductor 118 is exposed on both ends in order to crimp and/or connect to the electronics 150 for the cleaning and inspection system 100. The sheath 108 may be constructed in many forms to pursue various advantages in the housing of the at least one electrical conductor 118, as demonstrated in the ensuing Figures described herein.

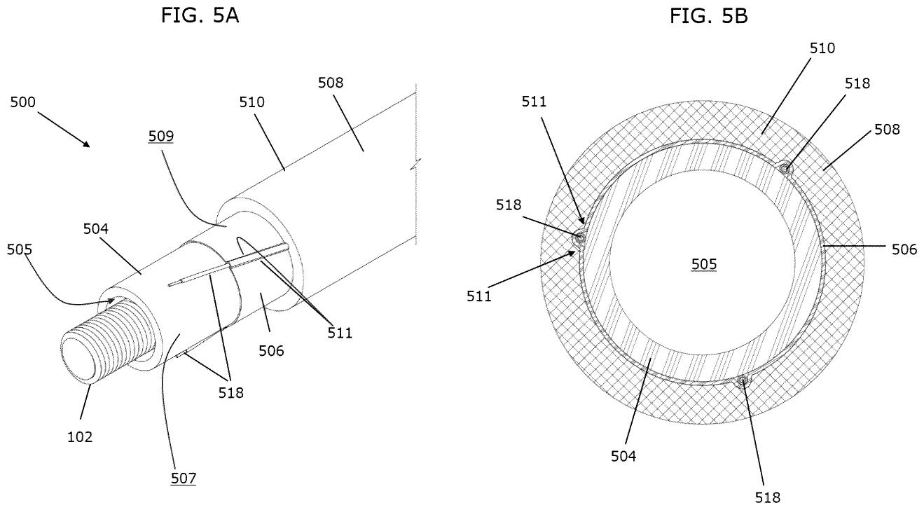

FIG. 5A is an isometric view of an example of a sheath assembly 500, according to one or more embodiments. As shown, the sheath assembly 500 (hereinafter, the “sheath 500”) is arranged on the flexible shaft 102, and FIG. 5B is a cross-sectional view of the sheath 500 without the flexible shaft 102. In the illustrated embodiment, the sheath 500 includes a flexible tube body 510 and at least one electrical conductor 518 covered by (and contained within) the tube body 510. In this embodiment, the flexible tube body 510 of the sheath 500 includes a central tube 504 that defines a bore 505 through which the flexible shaft 102 may extend, a tape wrap 506 arranged on an outer surface 507 of the central tube 504, and an extruded jacket 508 arranged on an outer surface 509 of the tape wrap 506, wherein the at least one electrical conductor 518 helically extends along (and around) the flexible tube body 510 in between the central tube 504 and the tape wrap 506. In embodiments, the extruded jacket 508 (while being arranged over) is not bonded to the tape wrap 506, to thereby facilitate removal of portions of the extruded jacket 508 and the tape wrap 506 to facilitate assembly of the system 100 by exposing end portions of the electrical conductors 118 which may then be connected to other components, such as the camera 120 and the electronics 150. In other examples, however, at least a portion of the at least one electrical conductor 518 may extend substantially parallel to the flexible tube body 510 rather than helically wrapping around the central tube 504. The tape wrap 506 is configured to protect and at least partially fix the at least one electrical conductor 518 in its orientation (e.g., in its helical or parallel orientation) along the flexible tube body 510. For example, in the illustrated embodiment, the tape wrap 506 may be wrapped around the electrical conductors 518, with a portion of the tape wrap 506 being enveloped around the electrical conductors 518, as indicated at 511, so as to define a space for the electrical conductor 118 to extend. As will be appreciated, the tape wrap 506 and the extruded jacket 508 may fully cover/encapsulate the electrical conductors 518 (such that the electrical conductors 518 are contained within the flexible tube body 510), except at locations of the flexible tube body 510 where the electrical conductors 518 exit (or extend beyond) the flexible tube body 510 for being connected to other components, such as the camera 120 and the electronics 150 as detailed herein. For example, the electrical conductors 518 may extend beyond the distal end of the flexible tube body 510 for being electrically connected to the camera 120 and/or may exit a segment of the flexible tube body 510 for being attached to the electronics 150. In an embodiment, the tape wrap 506 may be a polytetrafluoroethylene (PTFE) film, a polyethylene terephthalate (PET) film, or other like material, or some combination thereof. However, other types of materials may be utilized to form the tape wrap 506 without departing from the present disclosure.

The extruded jacket 508 is configured to define a space within which the at least one electrical conductor 518 (and the tape wrap 506 covering it) may occupy in its helical extension along the outer surface 507 of the central tube 504. In an embodiment where the electrical conductors 518 include three (3) conductors, one of the electrical conductors 518 may be a shielded cable (e.g., a coaxial cable for data signal such as video transmission), and the other two electrical conductors 518 may be insulated conductors, e.g., for supplying power and creating a ground. In another embodiment where the electrical conductors 518 include three (3) conductors, all three (3) of the electrical conductors 518 may be insulated conductors. The extruded jacket 508 may be made from various materials, such as various types of polymeric materials that would provide flexibility, durability (wear/puncture resistance), chemical compatibility and lubricity (coefficient of friction). For example, the extruded jacket 508 may be made from polyolefins (polyethylene and polypropylene), cross-linked polyolefins, Nylon, and others alike. In other examples, the extruded jacket 508 may be made from PVC and/or silicone. In one example, the extruded jacket 508 is made from cross-linked polyethylene.

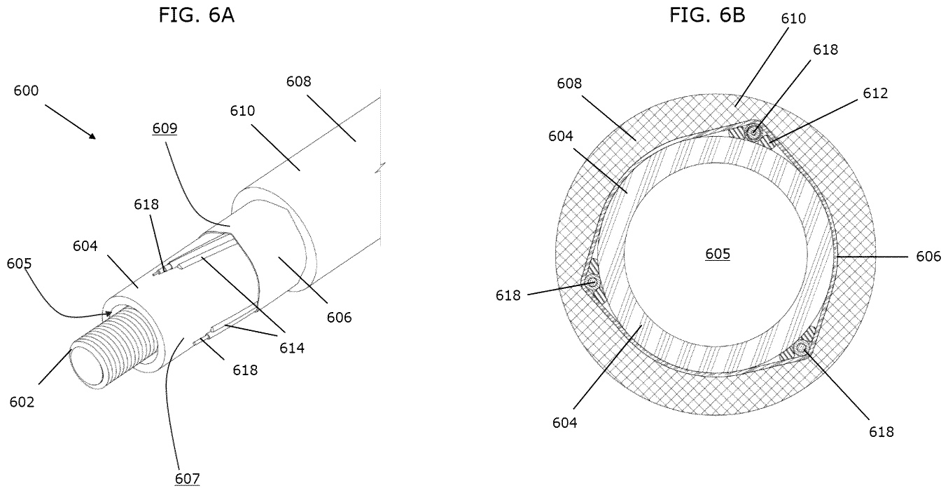

FIG. 6A is an isometric view of an example of a sheath assembly 600, according to one or more embodiments. As shown, the sheath assembly 600 (hereinafter, the “sheath 600”) is arranged on the flexible shaft 102, and FIG. 6B is a cross-sectional view of the sheath 600 without the flexible shaft 102. In the illustrated embodiment, the sheath 600 includes a flexible tube body 610 and at least one electrical conductor 618 covered by (and contained within) the tube body 610. In this embodiment, the tube body 610 of the sheath 600 includes a central tube 604 that defines a bore 505 through which the flexible tube 102 may extend, and a tape wrap 606 arranged on an outer surface 607 of the central tube 604. As illustrated, the sheath 600 may include a filler material 612 arranged in between the central tube 604 and the tape wrap 606, wherein the filler material 612 borders at least some of the at least one electrical conductors 618. In this example, the filler material 612 is provided on each side of the electrical conductors 618 and provided under the tape wrap 606; and, with this construction, when the tape wrap 606 is applied it is pulled tightly and does not fully envelope the underlying electrical conductors 618, but the filler material 612 fills these air gaps to inhibit lateral movement of the electrical conductors 618, and also helps to achieve a more uniform rounder shape. Thus, as shown, the filler material 614 boarders either side of each of the electrical conductors 618 and extends around the central tube 604 in a similar orientation (e.g., helical or parallel) as the electrical conductors 618. Here, the tube body 610 also includes a jacket 608 arranged on an outer surface 609 of the tape wrap 606, and the jacket 608 may be an extruded jacket. In embodiments, the filler material 612 is a paper filler material, a plastic filler material, a foam filler material, and/or a cotton filler material.

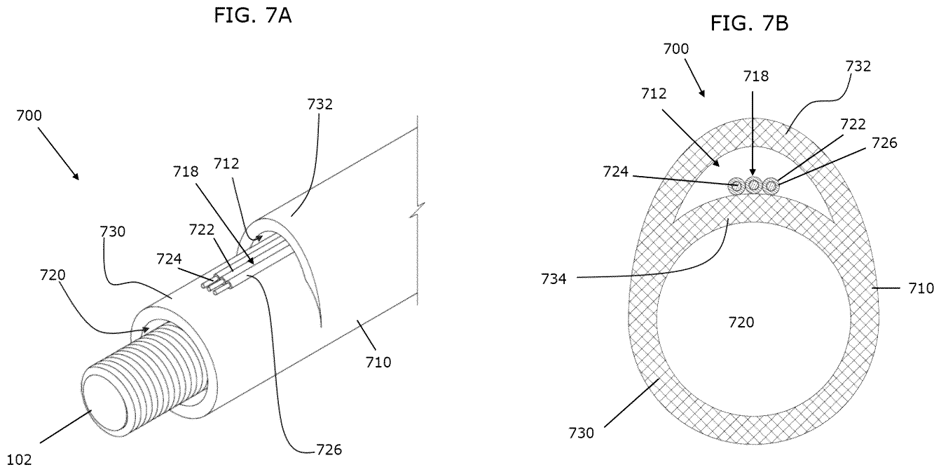

FIG. 7A is an isometric view of an example of a sheath assembly 700, according to one or more embodiments. As shown, the sheath assembly 700 (hereinafter, the “sheath 700”) is arranged on the flexible shaft 102, and FIG. 7B is a cross-sectional view of the sheath 700 without the flexible shaft 102. In the illustrated embodiment, the sheath 600 includes a flexible tube body 710 and at least one electrical conductor 718. The flexible tube body 710 defines a bore 720 through which the flexible shaft 102 extends when assembled. As illustrated, the sheath 700 may also define a lumen 712 that is separated (or partitioned) from the central bore 720, and the at least one electrical conductor 718 extends within the lumen 712 of the sheath 700. The bore 720 and the lumen 712 (collectively, the dual lumens) that is separated/partitioned from the bore 720 may be created/formed during manufacture of the flexible tube body 710, for example, during extrusion of the flexible tube body 710, wherein the size/diameter and/or relative location of the dual lumens relative to each other may be defined by the extrusion die. In other non-illustrated embodiments, the flexible tube body 710 is extruded to include at least one additional lumen (in addition to the bore 720 and the first lumen 712), and in such embodiments, one or more electrical conductors 718 may extend through the additional lumen and one or more other electrical conductors 718 may extend through the first lumen 712.

The lumen 712 is configured to provide a secondary structural cavity within the flexible tube body 710 for the at least one electrical conductor 718 to traverse and while providing for the at least one electrical conductor 718 contained in the lumen 712. Here, the flexible tube body 710 includes a base portion 730 and a lumen portion 732 arranged on the base portion 730, wherein the bore 720 is defined within the base portion 730 and the lumen 712 is defined at least partially within the lumen portion 732; and, in the illustrated embodiment, the lumen 712 is defined between the lumen portion 732 and the base portion 730, with a portion 734 of the base portion 730 forming a barrier or partition between the bore 720 and the lumen 712. In embodiments, the flexible tube body 710 is configured such that the lumen 712 extends along the length of the flexible tube body 710 in an orientation that is generally parallel with the bore 720; however, in other embodiments, the flexible tube body 710 may be configured such that the lumen 712 extends helically around and along the length of the flexible tube body 710 In embodiments, the at least one electrical conductor 718 may also include a ribbon cable 722 having a plurality of wires 724 shielded/covered with an insulator material 726. In embodiments, the camera 120 may be arranged within the distal opening of the lumen 712, thereby facilitating connection between the camera 120 and the electrical conductors 118 without the need for including the mount 144.

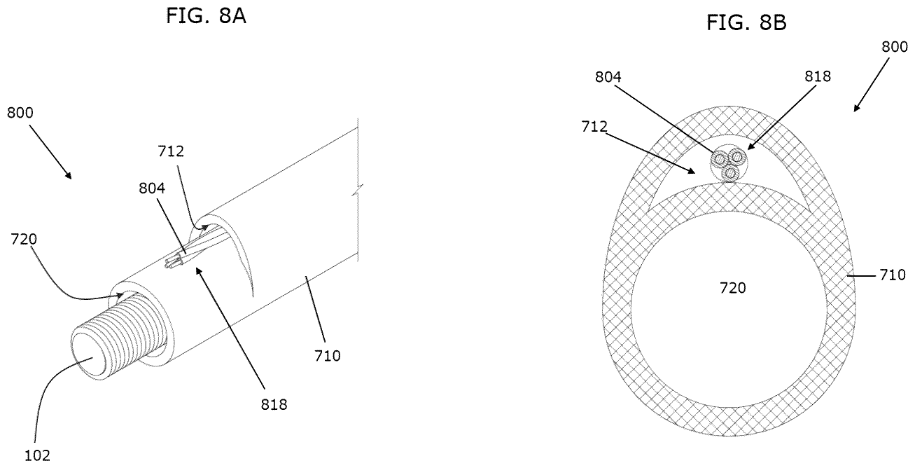

FIGS. 8A and 8B are isometric and cross-sectional views of another example sheath assembly 800, according to one or more alternate embodiment. The sheath assembly 800 (hereinafter, the “sheath 800”) is similar to the sheath 700 of FIGS. 7A-7B, in that the sheath 800 similarly includes the flexible tube body 710 that defines the bore 720 for the flexible shaft 102 and lumen 712 within which at least one electrical conductor 818 may extend. In the illustrated embodiment, however, the at least one electrical conductor 818 comprise three wires (e.g., insulated wires) that are twisted together into a helix configuration 804, rather than the ribbon cable 722 of FIGS. 7A-7B. The helix configuration 804 may add additional stability to the at least one electrical conductor 818. The helix configuration 804 is configured to allow the at least one electrical conductor 818 to act in a spring-like manner, enabling an adequate capability to stretch, compress, and flex within the sheath 800, for example, when the sheath 800 is bent. Flexibility is desired within the sheath 800 due to such bending, because the conductors 818 may be subjected to a larger bending radius than the bending radius of the flexible shaft 102 when the sheath 800 is bent, and the conductors 818 when subjected to the larger bending radius may need additional slack to flex, otherwise the tension may break the conductors 818 or other electrical interconnections within the sheath 800.

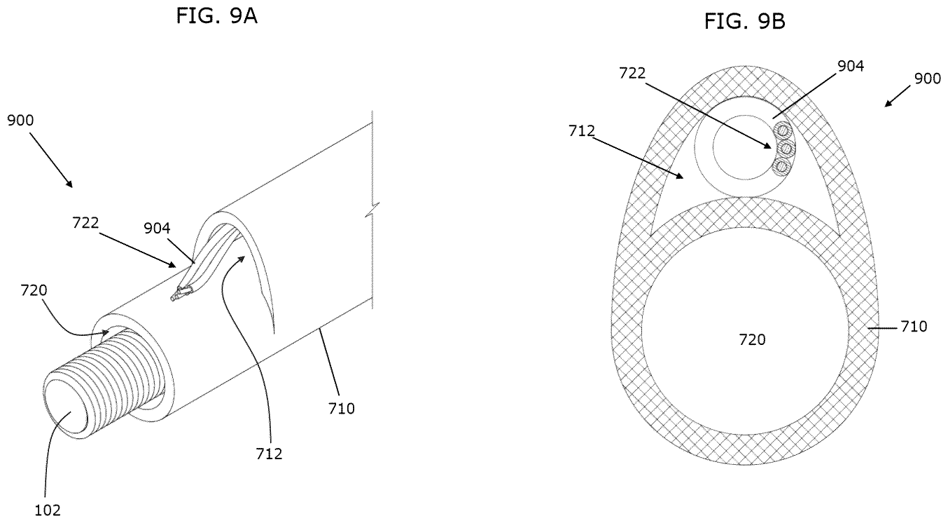

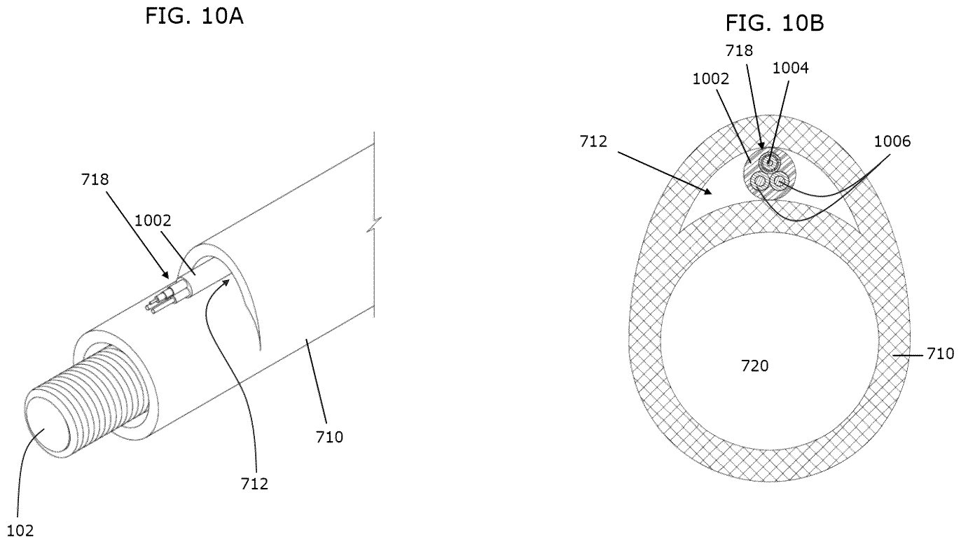

FIGS. 9A and 9B are isometric and cross-sectional views of yet another example of sheath assembly 900, according to one or more alternate embodiment. The sheath assembly 900 (hereinafter, the “sheath 900”) is similar to the sheath 700 of FIGS. 7A-7B, in that the sheath 900 similarly includes the flexible tube body 710 that defines the bore 720 for the flexible shaft 102 and lumen 712, and that the at one electrical conductor 718 is the ribbon cable 722 that extends within the lumen 712. In the illustrated embodiment, however, the ribbon cable 722 is twisted in a helix configuration 904. The helix configuration 904 of the ribbon cable may provide the ribbon cable 722 with additional flexibility, which may be beneficial when the lumen 712 is subjected to a larger bending radius than the bore 720, as mentioned above. The helix configuration 904 of the ribbon cable 722 provides the ribbon cable 722 with a helical spiral appearance, which in turn provides slack within the ribbon cable 722 that allows the conductors 718 contained in the ribbon cable 722 to both stretch and compress, which may be desirable depending on the various bending radii that the system 100 is subjected to within the pipe 101 during use. [In other embodiments, and with reference to FIGS. 10A and 10B, the at least one electrical conductor 718 may include a jacketed cable 1002 extending through the lumen 712, wherein the jacketed cable 1002 includes a wire 1004 that is insulated and shielded (hereinafter, the shielded wire 1004) and a pair of wires 1006 that are insulated but unshielded (hereinafter, the insulated wires 1006). The jacketed cable 1002 may facilitate assembly of the system 100, as it may be easier to install the jacketed cable 1002 during the assembly process. In embodiments, the shielded wire 1004 may be utilized to transmit data (e.g., camera data and/or sensor data from, for example, the accelerometer 171). However, in embodiments, the jacketed cable 1002 may include an additional shielded wire, for example, the jacketed cable 1002 may include a first shielded wire for transmitting camera data (from the camera 120) and a second shielded wire for transmitting other data (e.g., from the accelerometer 171), and in these embodiments the jacketed cable 1002 may also include one or more insulated wires for supplying power and/or grounding. In such embodiments, the first shielded wire may be in electrical communication with the camera 120 and a second shielded wire may be in electrical communication with the accelerometer 171, and the one or more insulated wires may be configured to supply power to the camera 120 and/or the accelerometer 171. In even other embodiments, none of the separate wires within the jacketed cable 1002 are shielded, but are just insulated wires, including the wires that are in communication with the camera 120 and/or the accelerometer 171 for transmitting/carrying data associated the camera 120 and/or the accelerometer 171. Thus, the jacketed cable 1002 may include one or more insulated wires, and any one or more of the insulated wires may be shielded or unshielded, and data may be transmitted through just a single one of the insulated wires, or more than one insulated wire used to transmit data (e.g., the camera 120 and the accelerometer 171 are in communication with separate electrical conductors 718).

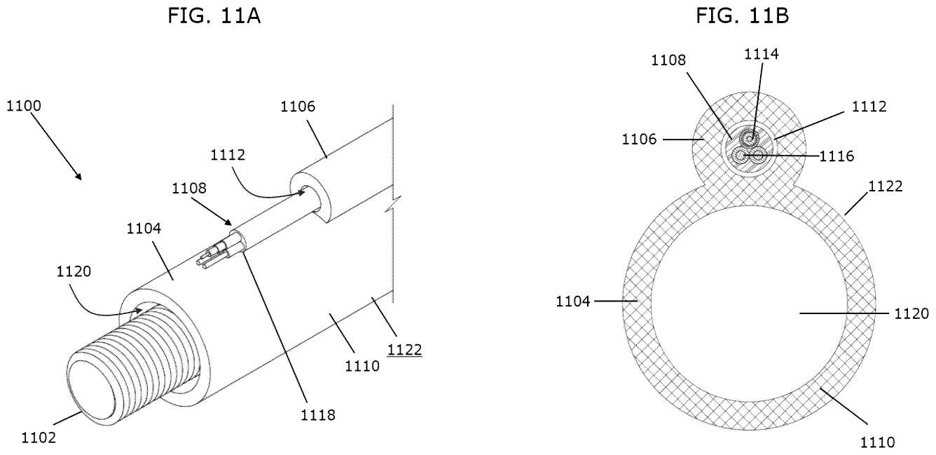

FIG. 11A is an isometric view of an example of a sheath assembly 1100, according to one or more embodiments. Here, the sheath assembly 1100 (hereinafter, the “sheath 1100”) includes a flexible tube body 1110 that defines a bore 1102, within which the flexible shaft 102 may extend when assembled. FIG. 11B depicts a cross section of the sheath 1100 of FIG. 11A without the flexible shaft 102. As illustrated, the flexible tube body 1110 of the sheath 1100 may include a larger tube body portion 1104 and a smaller tube body portion 1106 arranged on an outer surface 1122 of the larger tube body portion 1104. As shown, the bore 1120 is defined within the larger tube body portion 1104, and a lumen 1112 is defined within the smaller tube body portion 1106. The smaller tube body portion 1106 and the larger tube body portion 1104 may be separate tubes structures that are bonded together during assembly/manufacture to form/create/obtain the flexible tube body 1110.

The sheath 1100 also includes at least one electrical conductor 1118 that extends through the lumen 1112 and, in the illustrated embodiment, the at least one electrical conductor 1118 comprises a jacketed cable 1108 arranged in the lumen 1112. The jacketed cable 1108 may be configured similar to the jacketed cable 1002, above. In the illustrated embodiment, the jacketed cable 1108 includes having a shielded wire 1114 (e.g., for transmitting data received from the camera 120 and/or the accelerometer 171) and a pair insulated wires 1116 that are inserted in and extend through the lumen 1112 of the smaller tube body 1106. While the jacketed cable 1108 is depicted with the single shielded wire 1114, it may have more than one shielded wires (that extend through the same lumen 1112 or separate lumens in either the same smaller tube body 1106 or in separate smaller tube bodies), or it may have no shielded wires. Thus, in other non-illustrated embodiments, the jacketed cable 1108 may include one or more insulated wires, any one or more of them may be either shielded or unshielded; and, in such embodiments, a separate electrical conductor 1118 may be used to transmit data from accelerometer 171 back to the proximal end of the system 100 and the associated electronics 150 within the electrical enclosure 136.

The smaller body portion 1106 may be arranged on the larger body portion 1104 such that the lumen 1112 extends substantially parallel with the bore 1120, or the smaller body portion 1106 may helically extend around and along the larger body portion 1104, such that the lumen 112 is helically wrapped around the bore 1120 of the larger body portion 1104. In embodiments, the jacketed cable 1108 may alternatively be bonded to the larger tube body 1104 instead of being inserted into the lumen 1112 of the smaller tube body 1106.

In embodiments, the process of manufacturing the flexible tube body 1110 includes bonding the smaller tube body portion 1106 and the larger tube body portion 1104 together, and such bonding could include melting or welding multiple tubes together through various technologies, including thermal, radio frequency, or infrared heat. For example, the method of manufacturing the flexible tube body 1110 may include providing the larger tube body portion 1104 and the smaller tube body portion 1106 that is separate from the larger tube body portion 1104, and then securing/attaching/bonding the smaller tube body portion 1106 to the larger tube body portion 1104. The smaller tube body portion 1106 and the larger tube body portion 1104 can either be permanently bonded throughout their entire lengths or skip/partially bonded at certain increments, such that there are several discrete attachment points where the smaller tube body portion 1106 and the larger tube body portion 1104 are bonded/attached together. In another embodiment, a jacketed cable (e.g., the jacketed cable 1002 of FIGS. 10A-10B) is bonded directly to a tube (such as the larger tube body portion 1104), to thereby provide the “dual lumen” configuration with the electrical conductors being contained within one of the lumens. In even other embodiments, two or more of the smaller tube body portions 1106 are bonded to the larger tube body portion 1104 such that the flexible tube body 1110 includes a first lumen 1112 extending through the first smaller tube body 1106 and second lumen extending through the second smaller tube body, with one or more of the electrical conductors 118 extending through the first lumen 1112 of the first smaller tube body 1106 and with one or more other electrical conductors 118 extending through the second lumen that is defined in the second smaller tube body.

Referring again to FIG. 4, FIG. 4 also depicts an example end assembly 400 of the system 100, according to one or more embodiments. The end assembly 400 includes at least the distal end 112 of the flexible tube body 110, wherein the bore 116 extends through the flexible tube body 110. The end assembly 400 also includes at least one electrical conductor 118 at least partially contained within the material of the flexible tube body 110, wherein the at least one electrical conductor 118 extends through the wall thickness T of the material of the flexible tube body 110 toward the distal end 112. The end assembly 400 may also include the mount 144 arranged at the distal end 112 of the flexible tube body 110. In the illustrated embodiment, the mount 114 includes a first part 414 that is attached to the distal end 112 of the flexible tube body 110 and a second part 416 that is attachable to the first part 414, wherein the second part 416 may be configured to support the camera 120; however, in other embodiments, neither part 414, 416 is solely responsible for supporting the camera 120 and the camera 120 may be supported between the parts of the mount or the mount is a monolithic member within which the camera 120 may be installed. Here, the camera 120 is installable or supportable on/within the second part 416 of the mount 144, for example within the bore 1112 of the second part 416. In embodiments, the flexible tube body 110 of the sheath 108 is configured as described with reference to the flexible tube body 510 of FIGS. 5A-5B, the flexible tube body 610 of FIGS. 6A-6B, the flexible tube body 710 of FIGS. 7A-10B, or the flexible tube body 1110 of FIGS. 11A-11B.

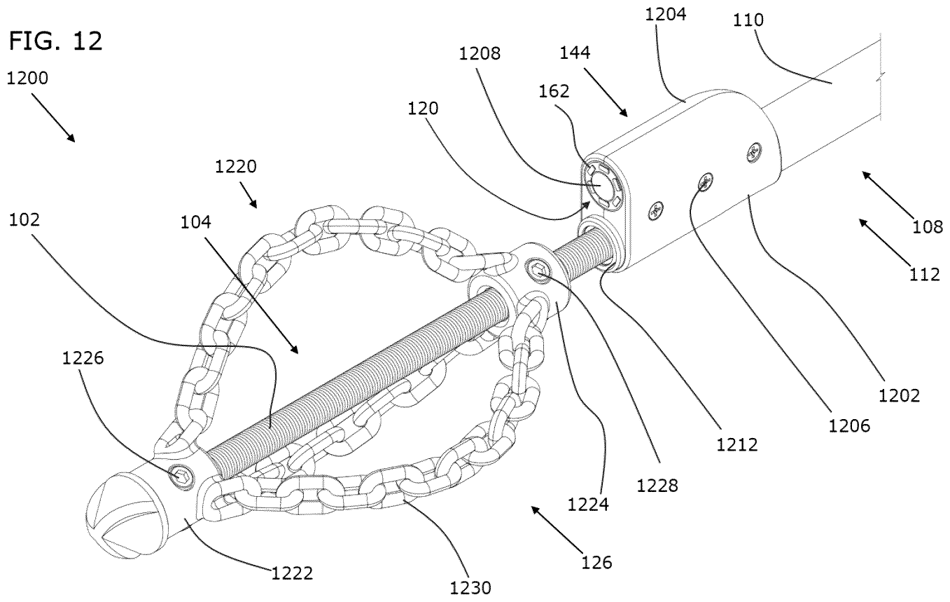

Referring now to FIGS. 12-16, an alternate end assembly 1200 that is utilizable with the system 100 is depicted, according to one or more embodiments.

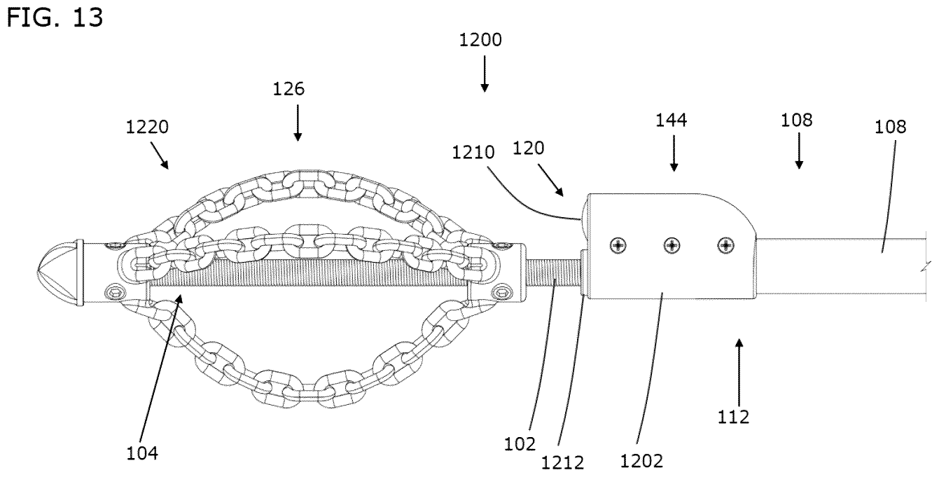

In the illustrated embodiment, the mount 144 is a two part housing within which the camera 120 is supported. In this embodiment, the mount 144 includes a first part 1202 and a second part 1204, wherein the first part 1202 and the second part 1204 are secured together via a plurality of fasteners 1206. Also in the illustrated embodiment, the LED 162 is integrated within the camera 120 module, and the LED 162 is arranged as a ring shaped light that surrounds an aperture 1208 of the camera 120. In this example, and as shown in FIG. 13, the camera 120 further includes a lens (or transparent cover) 1210 that covers both the aperture 1208 and the LED 162. The lens 1210 may be any lens that provides an adequate field of view for inspecting the narrow interiors of pipes and drains. a fish-eyed lens. For example, the lens 1210 may be a fisheye lens or a pin-hole lens. The lens 1210 may also include the capability to adjust focus. Other types of lenses may also be utilized without departing from the present disclosure.

The mount 114 surrounds at least some length of the distal end 112 of the flexible tube body 110 of the sheath 108. Further, in the illustrated embodiment, a ferrule 1212 is arranged at the distal end 112 of the flexible tube body 110, and the first part 1202 and the second part 1204 of the mount 144 also surround and contain at least part of the ferrule 1212. The ferrule 1212 is configured to protect against wear from where the flexible shaft 102 may contact the flexible tube body 110 or an edge of the mount 144. In the illustrated embodiment, the flexible tube body 110 is configured as described with reference to the flexible tube body 710 of FIGS. 7A-10B, and the flexible tube body 110 may be made from various materials, including without limitation a cross-linked polyethylene.

These figures also depict an example where the bit 126 is a chain knocker 1220. Here, the chain knocker 1220 includes a pair of collars 1222, 1224 (i.e., a distal collar 1222 and a proximal collar 1224), wherein the proximal collar 1224 includes a bore (that extends through the proximal collar 1224) through which the flexible shaft 102 may extend when installing the chain knicker 1220, and the distal collar 1222 also includes a bore that extends at least partially through the distal collar 1222. When installing the chain knocker 1220 on the flexible shaft 102, the distal end 104 of the flexible shaft 102 extends fully through the bore in the proximal shaft 1224 and then the flexible shaft 102 extends into the bore in the bore in the distal collar 1222. The chain knocker 1220 also includes set screws 1226, 1228 that may then be tightened to secure/lock the collars 1222, 1224 on the flexible shaft 102. The chain knocker 1220 also includes strands of chain 1230 extending between the distal collar 1222 and the proximal collar 1224. During operation, as the flexible shaft 102 is rotated, the chains 1230 are flung radially outward (away from the flexible shaft 102) and contact the interior wall of the pipe/drain “knocking” away debris. While not illustrated, cutting elements may be provided on the chains 1230 to facilitate cutting of debris within the pipe 101. For example, in embodiments, the cutting element may include a cutting blade used in a cast iron pipe configured to provide additional cutting ability to remove roots or rust/scale from the inside of the pipe. The chain knocker 1220 may be constructed of any combination of durable materials that are resistant to corrosion or other wear and tear. For example, the chain knocker 1220 could be constructed of (but not limited to) steel, hardened steel, brass, copper, plastics or nylon, or other composite materials. The chain knocker 1120 may be made of other materials without departing from the present disclosure.

To remove the chain knocker 1220, the set screws 1226, 1228 are loosened and the bit 126 can slide off the flexible shaft 102. Alternatively, crimp collars could be attached to the flexible shaft 102, and the same bit 126 could slide over these crimp collars and be tightened down on these crimp collars. This further protects the flexible shaft 102 from potential damage by providing a surface for the set screws 1226, 1228 to contact when tightened, for example, the crimp collars may provide an extra layer that would prevent damage that may otherwise occur if the set screws 1226, 1228 are overtightened and can cut into the flexible shaft 102. Furthermore, T-slide connectors could also be fastened to the distal end 104 of the flexible shaft 102 for connecting the bit 126 to the flexible shaft 102. Such T-slide connectors could be secured by crimping or via set screw(s). The bit 126 would then have a mating T-slide connector that attaches to the connector fixed on the flexible shaft 102. Detachability of the chain knocker 1220 allows for convenient switching between different tools or accessories for the inspection or cleaning of pipes and drains.

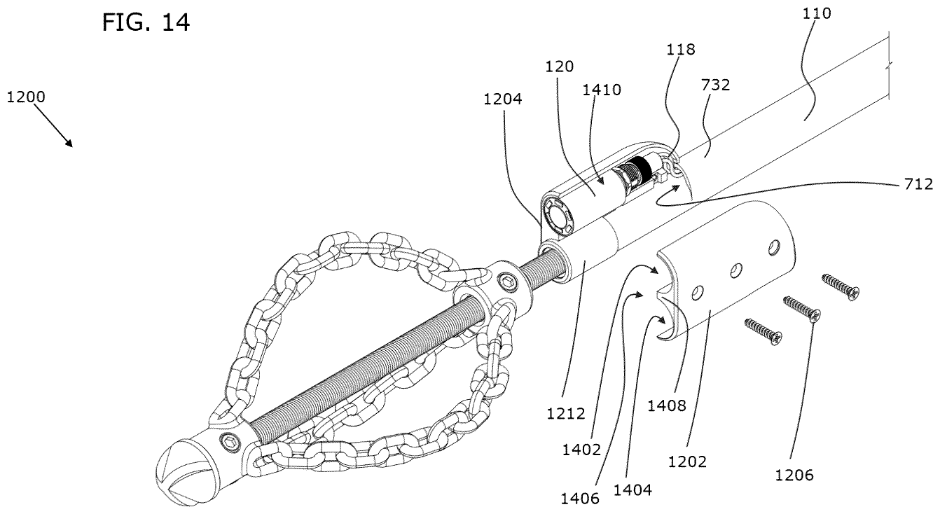

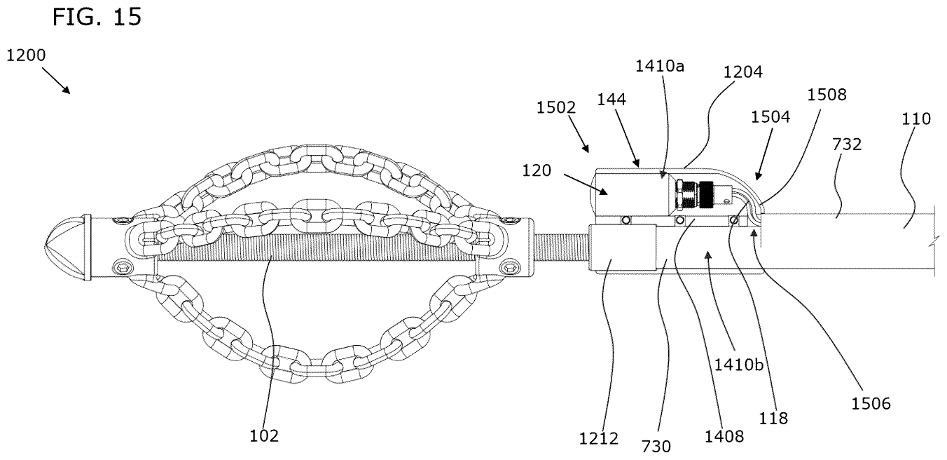

As shown in FIGS. 12-13, the mount 144 is arranged at the distal end 108 of the flexible tube body 110 such that the electrical conductors 118 are unexposed to the ambient environment (exterior of the system 100) to thereby protect the electrical conductors 118 within the sheath 108 and the mount 144. Referring now to FIGS. 14 and 15, the end assembly 1200 is depicted with the first part 1202 of the mount 144 having been removed so as to expose the camera 120 housed within the mount 144. As shown, each part 1202, 1204 of the mount 144 includes a half cylindrical shaped bore 1402, 1404 formed on an inner side 1406 of the parts 1202, 1204, wherein the half cylindrical shaped bore 1402, 1404 are separated by a divider 1408. When the parts 1202, 1204 are assembled together, with their inner sides 1406 facing each other, the half cylindrical shaped bore 1402, 1404 of the parts 1202, 1204 will define an upper bore 1410a (defined by half cylindrical bores 1402) and a lower bore 1410b (defined by half cylindrical bores 1404), wherein the flexible tube body 110 (and the ferrule 1212) are arranged in the lower bore 1410b and the camera 120 is arranged in the upper bore 1410a. Accordingly, in the illustrated embodiment, the interior 1410 of the mount 144 includes the upper and lower bore 1410a,b, which are defined within the mount 144, wherein the camera 120 is arranged in the upper bore 1410a of the mount 144 and the distal end 112 of the flexible tube body 110 (and the ferrule 1212) are arranged in the lower bore 1410b of the mount 144. Also in the illustrated embodiment, the lumen 712 of the sheath 108 is in fluid communication with an interior 1410 of the mount 144 to allow the electrical conductors 118 to extend directly into the interior 1410 of the mount 144 without being exposed to an exterior environment outside of the sheath 108 and the mount 144.

As best shown in FIG. 15, the mount 144 includes a distal end 1502 and a proximal end 1504, and an opening 1506 is defined in the rear end 1504 of the mount 144. When the mount 144 is installed on the flexible tube body 110, the opening 1506 is in communication with the lumen 712 within the flexible tube body 110, such that electrical conductors 118 may extend through the lumen 712, through the opening 1506 in the mount 144, and into the interior 1410 of the mount 144. As shown, in the illustrated embodiment, the proximal end 1504 of the mount 144 includes a hood structure 1508 that engages/contacts the exposed outer surface of the lumen portion 732 of the flexible tube body 110, to thereby create a water tight seal between the mount 144 and the flexible tube body 110 and thereby inhibit fluids or debris from entering the interior of the mount 144 and/or the lumen 712. Accordingly, the lumen 712 of the flexible tube body 110 is in fluid communication with the interior 1410 of the mount 144, with the electrical conductors 118 extending out of the lumen 712 and into the interior 1410 of the mount 144 through opening 1506 in the mount 144, such that the electrical conductors are contained within the flexible tube body 110 and the mount 144 and not otherwise exposed to ambient environments which could damage the electrical conductors 118.

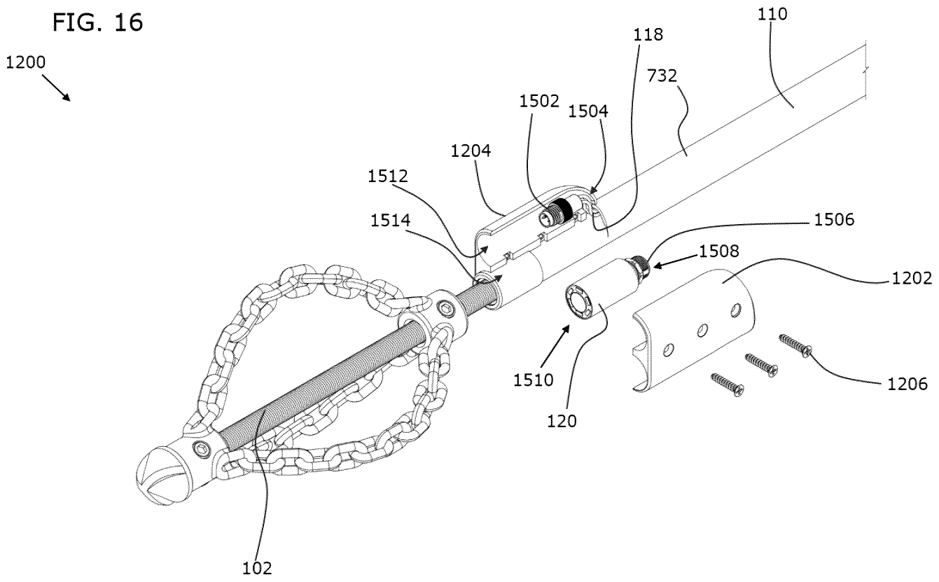

As shown in FIG. 16, which depicts the end assembly 1200 with components exploded therefrom, a first connector 1502 is arranged at the distal end 1504 of the electrical connectors 118 and a second connector 1506 is arranged at a proximal end 1508 of the camera 120. In the illustrated embodiment, the first connector 1502 of the electrical conductors 118 is a male waterproof connector, and is utilized for establishing an electrical connection for each of the electrical conductors 118. Similarly, the second connector 1506 is a female waterproof connector configured to mate with the first connector 1502 and establish a waterproof electrical connection between the electrical conductors 118 and the camera 120. As depicted in FIG. 16, the camera 120 is removable from the mount 144, for example, by removing the first part 1202 and then disconnecting the camera 120 from the first connector 1502, and then removing the camera 120 from the upper bore 1512 defined within the mount (wherein the lower bore 1514 defined within the mount is beneath the upper bore 1512 and the ferrule 1212 and the flexible tube body 110 are arranged within the lower bore 1514). As shown, the camera 120 includes a distal end 1510 opposite the proximal end 1508, wherein the aperture and LED 162 are arranged at the distal end 1510.

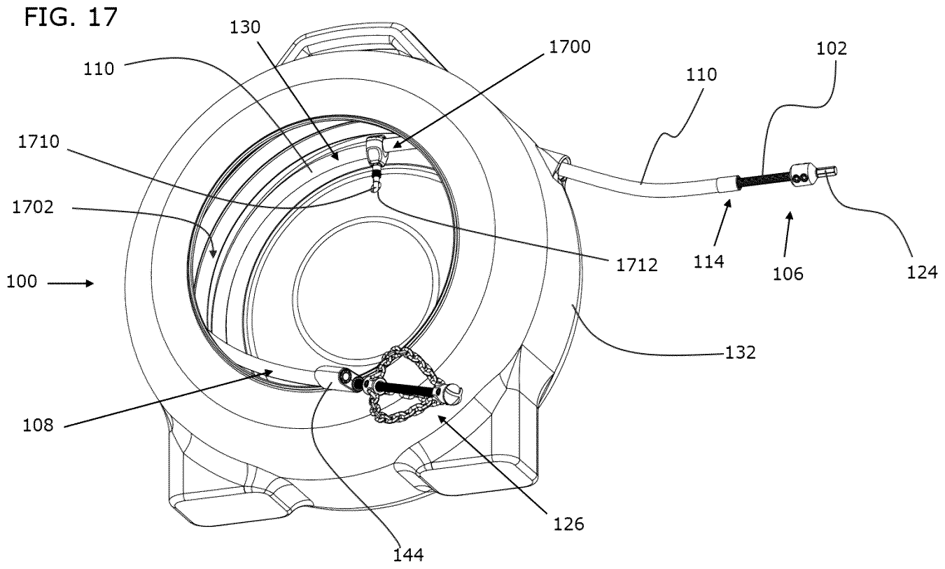

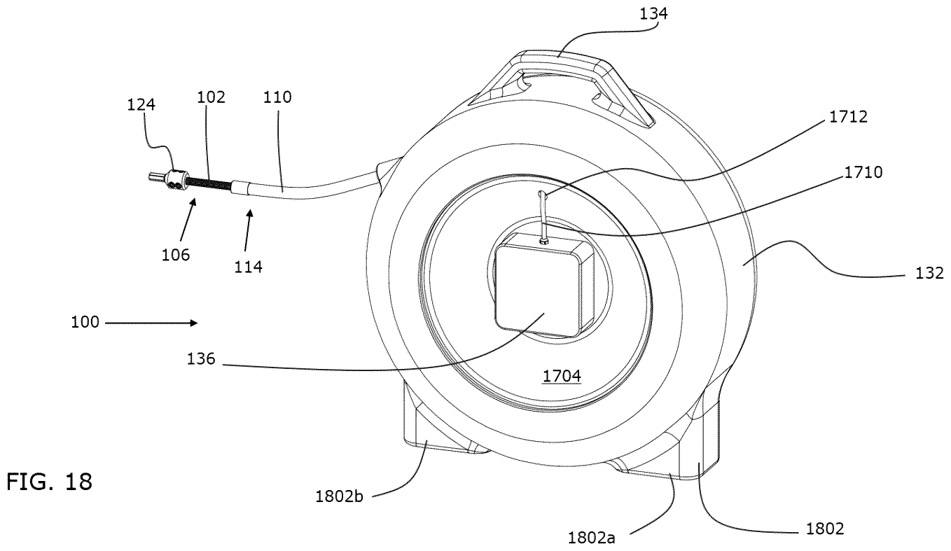

Referring now to FIGS. 17-22, embodiments for establishing electrical communication between the electrical conductors 118 and the electrical enclosure 136 are depicted, according to one or more embodiments. In particular, FIG. 17 depicts a front side view of the system 100, whereas FIG. 18 depicts a rear side view of the system 100, according to embodiments. As shown in at least FIG. 17, the sheath 108 and the flexible shaft 102, having the bit 126 installed at the distal end 104 thereof, may be stored within an interior space 1702 defined within the case 132. In the illustrated embodiment, the electrical enclosure 136 is mounted to an outside surface 1704 on the rear side of the case 132, as shown in FIG. 18. The case 132 may further include a base 1802 defined to provide stable platform from which the case 132 may stand and balance freely upright. The base 1802 may be located opposite the handle 134 in order to provide convenient carrying and stationary setting of the system 100 during use or when not being used. In the illustrated embodiment, the base 1802 includes a pair of feet 1804a,b. While not illustrated, the case 132 may have a drain opening in which a plug may be inserted to close the drain opening, wherein the drain opening is utilizable to drain any fluid that may be captured within the case 132 during use. In embodiments, a drain opening with associated plug is provided in the bottom of each of the feet 1804a,b.

In the illustrated embodiment, the sheath 108 includes an electrical transition assembly 1700 for establishing electrical communication between the electrical conductors 118 and the electronics 150 contained in the electrical enclosure 136. As shown, the electrical transition assembly 1700 (hereinafter, the assembly 1700) includes an electrical cable 1710 that extends from the assembly 1700 to the electronics 150 contained within the enclosure 136. As shown in FIG. 17, the assembly 1700 is attached to the flexible tube body 110 of the sheath 108 at a location within the interior space 1702 of the case 132, and the electrical cable 1710 extends from the assembly 1700 through an opening/hole 1712 in the case 132 and to the electrical enclosure 136 that is mounted on the exterior surface 1704 of the case 132, as shown in FIG. 18. In embodiments, the assembly 1700 is fixed/secured to the case 132, so as to inhibit relative movement between the assembly 1700 and the case 132 which will help ensure that the electrical conductors 118 are not ripped or pulled out of their connection with the electronics 150. The electrical cable 1710 contains and/or internally includes one or more electrical conductors (not depicted), and each of the electrical conductors within the electrical cable 1710 may correspond to/with one of the electrical conductors 118 within the flexible tube body 110.

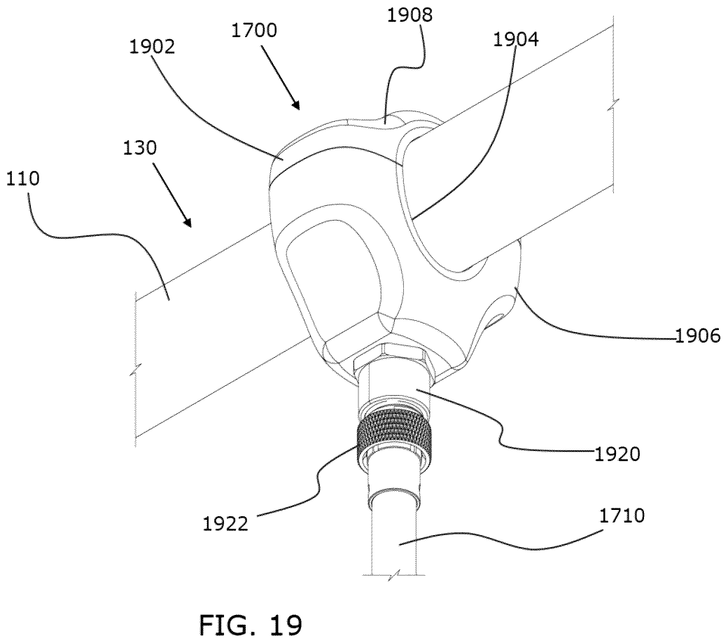

FIG. 19 depicts the assembly 1700 installed on the flexible tube body 110 of the sheath 108, according to embodiments. The assembly 1700 may be installed at various locations (i.e., at different lengths) of the flexible tube body 110, for example, at the central segment 130, where the electrical conductors 118 are extending through and contained within the flexible tube body 110. As described herein, the assembly 1700 is configured to provide a means for the electrical conductors 118 to exit the flexible tube body 110 such that they may be (directly or indirectly) connected to the electronics 150 within the electrical enclosure 136, while still providing protection to the electrical conductors 118 such that they are not exposed to the elements or ambient environment which could cause damage to them. In embodiments, the assembly 1700 may be detachable without exposing the electrical conductors 118 to the elements or ambient environment. Accordingly, the assembly 1700 provides a transition whereby the electrical conductors 118 may exit the flexible tube body (and/or be placed in electrical communication with) the electronics 150 without being exposed to the exterior environment which may otherwise damage the electrical conductors 118 during use.

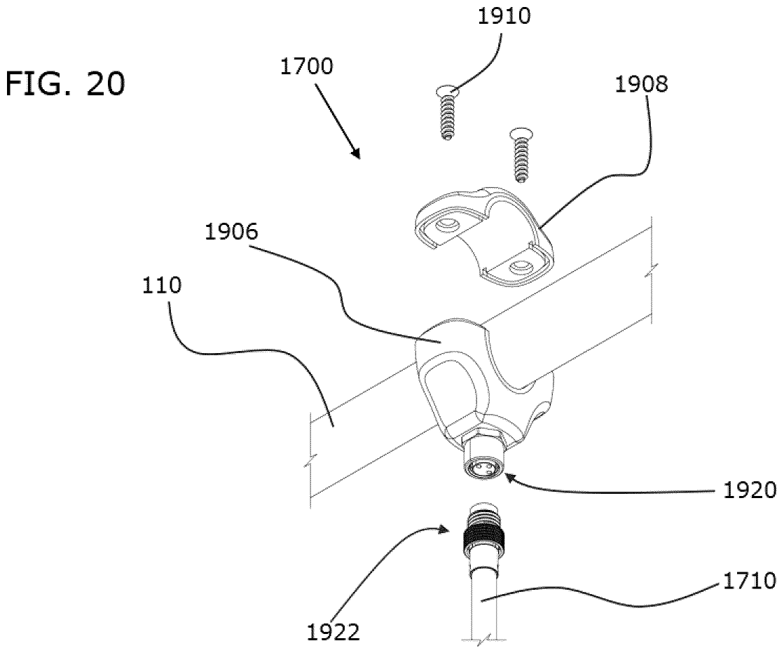

In the illustrated embodiment, the assembly 1700 includes a body 1902, and the body 1902 includes a bore 1904 through which the flexible tube body 110 extends. Here, the body 1902 is a two-part body, having a first part 1906 and a second part 1908 that are attachable together (around the flexible tube body 110) via a plurality of fasteners 1910 (FIG. 20), such that when attached, the first part 1906 and the second part 1908 combine to define the bore 1904. FIG. 20 depicts an exploded view of the assembly 1700, such that FIG. 20 depicts an example where the assembly 1700 is disassembled.

As shown, the assembly 1700 includes a connector 1920 operatively connected to and extending from the body 1902, and the connector 1920 is configured to mate with a corresponding connector 1922 of the electrical cable 1710. In the illustrated embodiment, the connector 1920 is a female water proof connector that is in electrical communication with the electrical conductors 118 within the flexible tube body 110, and the corresponding connector 1922 is a male water proof electrical connector that is attached to the end of the electrical cable 1710, and the electrical cable 1710 is electrically connected to the electronics 150 within the electrical enclosure 136, such that the user may selectively attach the corresponding connector 1922 of the cable 1710 to the connector 1920 of the assembly 1700 to thereby electrically connect the electrical conductors 118 to the electronics 150 in the electrical enclosure 136 (i.e., the user may establish electrical connection between the electrical conductors 118 and the electronics 150 via connecting the connectors 1920, 1922 together).

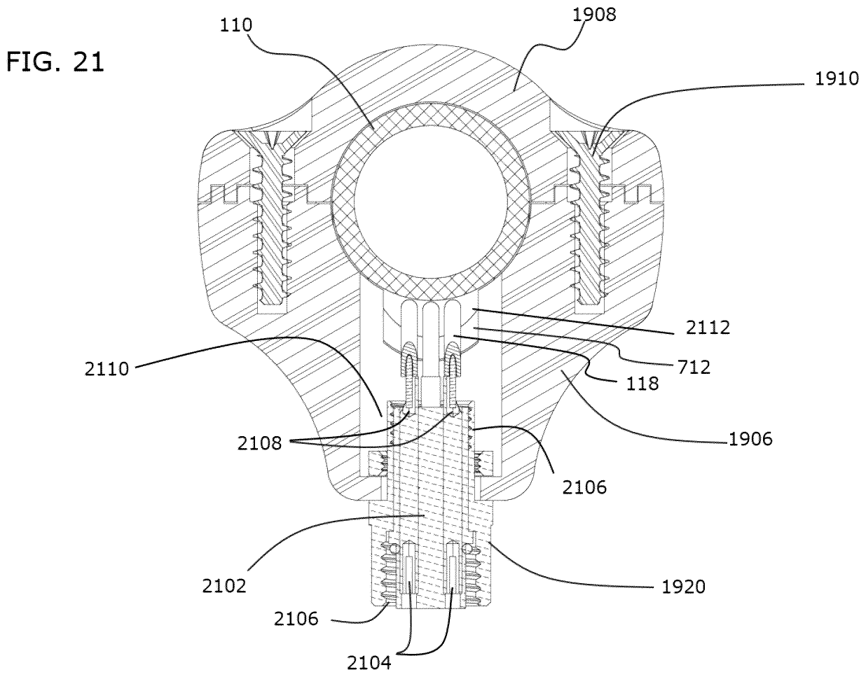

FIG. 21 depicts a front cross-sectional view of assembly 1700 with first part 1906 and second part 1908 fastened together by a plurality of fasteners 1910, according to embodiments. The connector 1920 of the assembly 1700 may further define a connector cavity 2102, wherein the corresponding connector 1922 attached to cable 1710 may be inserted to thereby established the aforementioned electrical communication between electrical conductors 118 to the electronics 150 in the electrical enclosure 136. The connector cavity 2102 may further include connector threads 2106, to provide a fastenable connection between the connector 1920 and the corresponding connector 1922 in embodiments where the connector 1920 may be female and the corresponding connector 1922 may be male, as illustrated in FIG. 21. The connector cavity 2102 may include electrical conduits 2104 through which the electrical conductors 118 within the flexible tube body 110 may establish electrical communication with the electrical conductors 118 of the electrical cable 1710. The connector cavity 2102 may further provide waterproofing capabilities such that the internal electrical conduits 2104 or any other communicable electrical conductors 118 within are not exposed to the elements or ambient environment which could cause damage to them. As illustrated, the electrical conduits 2104 may be connected to assembly electrical conduits 2108 located proximate to the part of the body 1902 that defines a cavity 2110, such that the electrical conductors 118 inside the flexible tube body 110 when inserted into the bore 1904 may be (directly or indirectly) connected to the assembly electrical conduits 2108 or other communicable electrical conductors 118 within the connector cavity 2102 (and thus, to electrical conduits 2104), such that full electrical communication is established between the electronics 150 in the electrical enclosure 136 and any electrical attachments at the distal end 108 of the flexible tube shaft 110 or the end assembly 1200, such as the camera 120.

The body 1902 may further include an opening 2112, through which electric conductors 118 extending outward from the lumen 712 of the flexible tube body 110 may extend into the cavity 2110 and otherwise establish aforementioned electrical communications. In other embodiments, the assembly electrical conduits 2108 may protrude through a part of the body 1902 of the assembly 1700 that defines the bore 1904 to define electrical contact points on the inside cylindrical surface of the bore 1904 of the body 1902, as well as electrical contact points on the outer surface of the flexible tube body 110, such that electrical communication may be established by simple physical contact between the assembly 1700 and the flexible tube shaft 110 via their respective electrical contact points 2110. Other connector mechanisms may also be used, for example, the jacketed cable as illustrated in FIGS. 11A and 11B. Referring back to FIG. 21, the body 1902 of assembly 1700 may further include the cavity 2110 wherein the connector 1920 may be inserted, coupled to, or otherwise attached. For example, the cavity 2110 may also include threads 2106 such that the connector 1920 may be removable and attachable to the body 1902 of the assembly 1700 via screw-in and screw-out fastening.

In embodiments, the assembly 1700 may be made of metals such as aluminum, stainless steel, or copper; plastics such as polycarbonate, acrylonitrile butadiene styrene, or nylon; composites such as carbon fiber reinforced polymer or glass fiber reinforced polymer; ceramics or elastomers such as silicone rubber. However, other materials may be used to construct the assembly 1700 without departing from the present disclosure. In embodiments where the assembly 1700 is constructed of more than one parts, each part may be constructed of the same or different materials or any combination therein. The assembly 1700 may further include insulation to differentiate between any metallic electrical conduits 2108 arranged within the assembly 1700 and metallic materials the assembly 1700 may be constructed from.

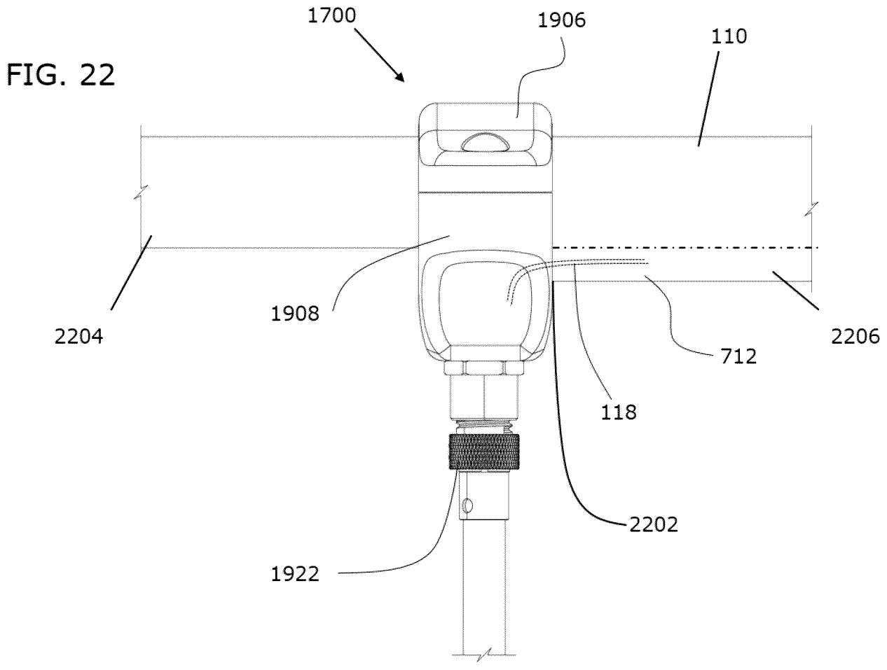

FIG. 22 depicts a side view of assembly 1700 with the first part 1906 and the second part 1908 of the body 1902 fastened together around a length of the flexible tube body 110 that includes a first part 2204 and a second part 2206. In this example, the disparate widths/diameters of the first part 2204 and the second part 2206 of the flexible tube body 110 may represent a termination point 2202 where the lumen 712 of the flexible tube body 110 ends and the flexible tube body 110 transitions back to a uniform cable having just a single bore through which the flexible shaft 102 may extend. The electrical conductors 118 (depicted by the dashed lines to illustrate a portion of the electrical conductors 118 are inside the lumen 712) running through the lumen 712 of the flexible tube body 110 may be redirected here at the termination point 2202 into the body 1902 of the assembly 1700 to establish aforementioned electrical communications. For example, as described above with reference to FIG. 21, the assembly 1700 may include an opening 2112 to receive the electrical conductors 118 from the lumen 712 of the flexible tube body 110. In embodiments, the opening 2112 may be constructed in the same size, shape, and materials such that a fluid connection with the lumen 712 at the termination point 2202 is enabled that allows the electrical conductors 118 to extend directly into the assembly 1700 without being exposed to an exterior environment outside of the sheath 108 and the assembly 1700. In embodiments, this fluid connection may be waterproof. In embodiments where assembly 1700 is absent, the lumen 712 of the flexible tube shaft may terminate at different locations. The opening 2112 may also be configured to receive the electrical conductors 118 in embodiments absent the lumen 712. For example, the flexible tube body 110 may include another insertion point from which the electrical conductors 118 may safety extend from the flexible tube body 110 to the assembly 1700 and thereby establish electrical communication with the electronics 150 in the electronic enclosure 136.

Also disclosed herein are methods of manufacturing and/or assembling the system 100. The method may include constructing a sheath assembly having flexible tube body, a bore defined in the flexible tube body, and at least one electrical conductor contained within a wall thickness of the flexible tube body. The method may also include supporting a camera at a distal end of the flexible tube body such that the camera is in electrical communication with distal end(s) of the at least one electrical conductor. In addition, the method may include connecting electronics contained in an electrical enclosure to proximal ends of the electrical conductors. The proximal ends of the electrical conductors may be directly connected to the electronics, or indirectly connected via one or more intervening conductors extending between the electronics and the proximal ends of the electrical conductors. The method may also include extending a flexible shaft through the bore of the flexible tube body, wherein the flexible shaft is operable to rotate independently of the flexible tube body of the sheath. In embodiments, the method may further include attaching a bit to a distal end of the flexible shaft and/or attaching a rotation device to a proximal end of the flexible shaft. The bit and/or the rotation device may be releasably attached to the distal end and the proximal end, respectively, of the flexible shaft. In embodiments, supporting the camera at the distal end of the flexible tube body may further include attaching a mount to the distal end of the flexible tube body and then attaching the camera to the mount or supporting the camera with the mount. In embodiments, the camera may be releasably attached to the mount and/or the mount may be releasably attached to the flexible tube body of the sheath. In addition, the method may include providing an LED, and such LED may be integrated within the mount or within the camera. In embodiments, the method further includes arranging at least a portion of the sheath and the flexible tube within a case; and, in such embodiments, the method may further include attaching the electrical enclosure to the case.

Also disclosed herein are methods of manufacturing sheath assemblies that are utilizable with the system 100. Such methods may include forming a flexible tube body with at least one electrical conductor contained within a wall thickness of the flexible tube body. Such method may further include running the at least one electrical conductor parallel to a bore that extends through the flexible tube body or running the at least one electrical conductor within the wall thickness helically around the bore. In embodiments, forming the flexible tube body includes extruding the flexible tube body with the at least one electrical conductor contained therein. In other embodiments, forming the flexible tube body includes extruding a tube body having a bore for the flexible shaft and a lumen that is separated/partitioned from the bore, and then the method may include feeding the electrical conductors within the lumen such that the at least one electrical conductor extends within the lumen and is contained within the lumen. In such embodiments, the at least one electrical conductor may include a plurality of wires, a plurality of wires twisted together, a ribbon cable, a ribbon cable twisted in a helical configuration, or a jacketed cable having shielded and insulated wires. In other embodiments, forming the flexible tube body includes providing a central tube defining a bore through which the flexible shaft may run, arranging a tap wrap on the central tube, arranging a jacket on the tape wrap, and inserting or running the at least one electrical conductor in between the central tube and the tape wrap. The inserting or running the at least one electrical conductor may include extending the at least one electrical conductor parallel to the bore or helically around the bore. In embodiments, the method further includes inserting a filler material in between the central tube and the tape wrap such that the filler material borders opposite sides of the electrical conductors.

In embodiments, the method of manufacturing the sheath assembly includes attaching a first tube body portion to a second tube body portion, wherein the first tube body portion includes a bore through which the flexible shaft may extend and the second tube body portion includes a lumen; and the method may thereafter include feeding the electrical conductors through the lumen such that the at least one electrical conductor extends within the lumen and is contained in the lumen. In these embodiments, the method may first include extruding the first tube body portion and extruding the second tube body portion.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The present disclosure is also directed to the following exemplary embodiments, which can be practiced in any combination thereof:

Embodiment A: A system for cleaning and inspecting a pipe, comprising: a flexible shaft having a distal end and a proximal end opposite the distal end; a sheath comprising a flexible tube body that extends over at least part of the flexible shaft and -includes a distal end and a proximal end, wherein the flexible tube body includes a bore within which the flexible shaft extends; at least one electrical conductor contained within the flexible tube body of the sheath, the at least one electrical conductor extending at least partially along a length of the flexible tube body; and a camera operatively connected to the at least one electrical conductor.

Embodiment B: A system for cleaning and inspecting a pipe, comprising: a flexible shaft having a distal end and a proximal end opposite the distal end; a sheath comprising a flexible tube body that extends over at least part of the flexible shaft and includes a distal end and a proximal end, wherein the flexible tube body includes a central bore within which the flexible shaft extends; at least one electrical conductor contained within the flexible tube body of the sheath, the at least one electrical conductor extending at least partially along a length of the flexible tube body; a mount disposed at the distal end of the flexible tube body, wherein the at least one electrical connector extends to the mount; and a camera detachably supported by the mount and operatively connected to the at least one electrical conductor.

Each of embodiments A through B may have one or more of the following additional elements in any combination: Element 1: the system comprises a mount disposed at the distal end of the flexible tube body, wherein the camera is supported by the mount. Element 2: the mount comprises at least a first part and a second part that is removeable from the second part. Element 3: the system comprises an electrical enclosure containing electronics that are operatively connected to the camera via the at least one electrical conductor, wherein the at least one electrical conductor is operatively connected to the electronics contained within the electrical enclosure. Element 4: the electronics comprises at least a battery operatively connected to the camera via the at least one electrical conductor. Element 5: the at least one electrical conductor includes a first conductor that interconnects the camera and the battery and a second conductor for transmitting data associated with the camera. Element 6: the second conductor is operatively coupled to the electronics, and the electronics is configured to wirelessly transmit the data to a remote device. Element 7: the system comprises an LED supported proximate to the distal end of the flexible tube, wherein the first conductor also supplies power to the LED. Element 8: the LED is integrated within the camera. Element 9: the LED comprises a ring of LEDs surrounding an aperture of the camera. Element 10: the system comprises a case from which the flexible shaft and the flexible tube body of the sheath may be extended or retracted. Element 11: the flexible tube body of the sheath comprises a central tube, a tape wrap arranged on the central tube, and an extruded jacket arranged on the tape wrap, wherein the at least one electrical conductor helically extends along the flexible tube body in between the central tube and the tape wrap. Element 12: the system comprises a filler material arranged in between the central tube and the tape wrap, wherein the filler material borders at least some of the electrical conductors. Element 13: the sheath comprises a lumen that is separated from the bore, wherein the at least one electrical conductor extends within the lumen of the sheath. Element 14: the at least one electrical conductor comprises: a ribbon cable having a plurality of wires; a ribbon cable having a plurality of wires that is twisted in a helix configuration; a plurality of insulated wires twisted together; or a jacketed cable having at least one shielded wire or at least one insulated wire. Element 15: the flexible tube body of the sheath comprises a larger tube body and a smaller tube body arranged on an outer surface of the larger tube body, wherein the bore is defined within the larger tube body, and the lumen is defined within the smaller tube body, and wherein the at least one electrical conductor comprises a jacketed cable. Element 16: the system comprises a rotation device operatively coupled to the proximal end of the flexible shaft, the rotation device being operable to rotate the flexible shaft relative to the sheath; and a bit operatively coupled to the distal end of the flexible shaft. Element 17: the system comprises an electrical transition assembly operatively coupling the at least one electrical conductor and the electronics, wherein a portion of the electrical transition assembly is arranged on the flexible tube body.

By way of non-liming example, exemplary combinations applicable to A through B include: Element 1 with Element 3; Element 2 with Element 3; Element 3 with Element 4; Element 2 with Element 5; Element 1 with Element 6; Element 7 with Element 8; Element 9 with Element 10; Element 1 with Element 12; Element 11 with Element 14; Element 13 with Element 16; Element 1 with Element 15; Element 15 with Element 17; and Element 2 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for cleaning and inspecting a pipe, comprising:
a flexible shaft having a distal end and a proximal end opposite the distal end;
a sheath comprising a flexible tube body that extends over at least part of the flexible shaft and includes a distal end and a proximal end, wherein the flexible tube body includes a bore within which the flexible shaft extends;
at least one electrical conductor contained within the flexible tube body of the sheath, the at least one electrical conductor extending at least partially along a length of the flexible tube body; and
a camera operatively connected to the at least one electrical conductor.

2. The system of claim 1, further comprising a mount disposed at the distal end of the flexible tube body, wherein the camera is supported by the mount.

3. The system of claim 2, wherein the mount includes at least a first part and a second part that is removable from the first part.

4. The system of claim 1, further comprising an electrical enclosure containing electronics that are operatively connected to the camera via the at least one electrical conductor, wherein the at least one electrical conductor is operatively connected to the electronics contained within the electrical enclosure.

5. The system of claim 4, wherein the electronics includes at least a battery operatively connected to the camera via the at least one electrical conductor.

6. The system of claim 5, wherein the at least one electrical conductor includes a first conductor that interconnects the camera and the battery and a second conductor for transmitting data associated with the camera.

7. The system of claim 6, wherein the second conductor is operatively coupled to the electronics, and the electronics is configured to wirelessly transmit the data to a remote device.

8. The system of claim 6, further comprising an LED supported proximate to the distal end of the flexible tube, wherein the first conductor also supplies power to the LED.

9. The system of claim 8, wherein the LED is integrated within the camera.

10. The system of claim 9, wherein the LED further comprises a ring of LEDs surrounding an aperture of the camera.

11. The system of claim 1, further comprising a case from which the flexible shaft and the flexible tube body of the sheath may be extended or retracted.

12. The system of claim 1, wherein the flexible tube body of the sheath further comprises a central tube, a tape wrap arranged on the central tube, and an extruded jacket arranged on the tape wrap, wherein the at least one electrical conductor helically extends along the flexible tube body in between the central tube and the tape wrap.

13. The system of claim 12, further comprising a filler material arranged in between the central tube and the tape wrap, wherein the filler material borders at least some of the electrical conductors.

14. The system of claim 1, wherein the sheath further includes a lumen that is separated from the bore, wherein the at least one electrical conductor extends within the lumen of the sheath.

15. The system of claim 14, wherein the at least one electrical conductor comprises:
a ribbon cable having a plurality of wires;
a ribbon cable having a plurality of wires that is twisted in a helix configuration;
a plurality of insulated wires twisted together; or
a jacketed cable having at least one shielded wire or at least one insulated wire.

16. The system of claim 14, wherein the flexible tube body of the sheath further comprises a larger tube body and a smaller tube body arranged on an outer surface of the larger tube body, wherein the bore is defined within the larger tube body, and the lumen is defined within the smaller tube body, and wherein the at least one electrical conductor comprises a jacketed cable.

17. The system of claim 1, further comprising:
a rotation device operatively coupled to the proximal end of the flexible shaft, the rotation device being operable to rotate the flexible shaft relative to the sheath; and
a bit operatively coupled to the distal end of the flexible shaft.

18. The system of claim 1, further comprising an electrical transition assembly operatively coupling the at least one electrical conductor and the electronics, wherein a portion of the electrical transition assembly is arranged on the flexible tube body.

19. A system for cleaning and inspecting a pipe, comprising:
a flexible shaft having a distal end and a proximal end opposite the distal end;
a sheath comprising a flexible tube body that extends over at least part of the flexible shaft and includes a distal end and a proximal end, wherein the flexible tube body includes a central bore within which the flexible shaft extends;
at least one electrical conductor contained within the flexible tube body of the sheath, the at least one electrical conductor extending at least partially along a length of the flexible tube body;
a mount disposed at the distal end of the flexible tube body, wherein the at least one electrical connector extends to the mount; and
a camera detachably supported by the mount and operatively connected to the at least one electrical conductor.

20. The system of claim 19, further comprising:
an electrical enclosure containing electronics that are operatively connected to the camera via the at least one electrical conductor, wherein the at least one electrical conductor is operatively connected to the electronics.
